(19) United States
(12) Patent Application Publication
(10) Pub. No.: US 2025/0104142 A1
(43) Pub. Date: Mar. 27, 2025

(54) MULTI-TENANT LOAN AND SUBSCRIPTION MANAGEMENT

(71) Applicants: Benjamin Eu-jin Hahr, Irvine, CA (US); Abraham Benjamin de Waal, San Jose, CA (US); Randy Jones, Pleasanton, CA (US)

(72) Inventors: Benjamin Eu-jin Hahr, Irvine, CA (US); Abraham Benjamin de Waal, San Jose, CA (US); Randy Jones, Pleasanton, CA (US)

(21) Appl. No.: 18/471,947

(22) Filed: Sep. 21, 2023

(51) Int. Cl. G06Q 40/03; G06Q 20/12

(52) U.S. Cl. CPC G06Q 40/03; G06Q 20/127

(57) ABSTRACT

In a first user session, first order data is received relating to a first subscription offering. Based on a user acceptance of and access to a first loan under a financing offer presented during a check out flow, a first payment may be received. In a second user session, a second payment is received. A determination is made whether a payment under the first loan is due, or whether the first loan is paid off. Based on a determination that a payment under the first loan is due, the second payment is applied to the first loan. Alternatively, based on a determination that the first loan is paid off, the second payment is applied as a credit to a user account, or as payment for an item or service in a check out flow in the second user session.

### TECHNICAL FIELD

Embodiments herein generally relate to encrypted data structures in a multi-tenant loan and subscription management system. More specifically, but not by way of limitation, embodiments relate to systems, methods, and media for enabling more convenient user interfaces and providing technically improved encryption in loan and subscription management processes and conversions.

### BACKGROUND

Creating, configuring, and managing a service platform in a multi-tenant environment is difficult and presents technical challenges. This is particularly so where product or service offerings are part of a bundle of offerings or services offered by a multitude of different tenants, and where payment may be made by members as a one-time payment in full, or as part of a subscription plan, or under a third-party loan. Each payment needs to be carefully categorized in order to comply with accounting rules, for example.

Each tenant may wish to create a different or unique program within a given plan, for example. Because this area of the software is frequently used on a touchscreen tablet device while the customer is watching, there is a need to have a fast, friction free to enter the data and present subscription and loan payments on the fly.

Creating and managing subscription programs across many different tenants in a multi-tenant environment, each with their own systems and requirements, requires solving many technical challenges around integration, data management, and configuration. Allowing each tenant to have a unique program requires a technical solution that can be synchronously and flexibly configured and customized for each tenant. Providing an interface that is fast and easy to use requires solving technical challenges around user experience design and system performance. Executing programs in real-time during payment transactions requires technical solutions for integrating the service platform with payment processing systems and calculating loyalty rewards on-the-fly.

More specifically, user interfaces and data structures pertaining to the management of subscriptions and loans (e.g., for goods or services), while having advanced in recent years, have not been optimized for use in a cross number of verticals and also for the management of more complicated hybrid subscription and loan arrangements between tenants (for example, service providers) and their customers in a multi-tenant network.

One prior art system for providing subscriptions to a bundle of services, and more specifically channels from a program guide, is described in U.S. Pat. No. 7,596,797 (the '797 patent). Here, a terminal controller is used to select a bundle of channels based on a subscription matrix of a user. However, the technology described in the '797 patent is inflexible, lacks configurability by a service provider and also provides a limited set of options for an end-user or consumer.

### BRIEF SUMMARY

Some examples herein relate generally to a multi-tenant loan and subscription management. More specifically, but not by way of limitation, embodiments herein generally relate to encrypted data structures in a multi-tenant loan and subscription management system. More specifically, but not by way of limitation, embodiments relate to systems, methods, and media for enabling more convenient user interfaces and providing technically improved encryption in loan and subscription management processes and conversions.

### BRIEF DESCRIPTION OF THE SEVERAL VIEWS OF THE DRAWINGS

FIG. 1 illustrates a networked multi-tenant network in which the described technology, according to some example embodiments, may be deployed.

FIG. 2 is a diagrammatic representation of a processing environment, in accordance with one embodiment.

FIG. 3 illustrates further details regarding the subcomponents of a loan and subscription management system, according to some example embodiments.

FIG. 4 is a block diagram illustrating further architectural details of a loan and subscription management system, according to some example embodiments.

FIG. 5 is a diagrammatic representation of data structures maintained by a loan and subscription management system, according to some example embodiments.

FIG. 6 is a block diagram of a data architecture, according to some example embodiments.

FIG. 7 illustrates example operations of a method in accordance with an example embodiment.

FIG. 8 illustrates an aspect of the subject matter in accordance with one embodiment.

FIG. 9 illustrates a method 900 for managing loans and subscriptions in a multi-tenant environment, the computer-implemented method in accordance with one embodiment.

FIG. 10-FIG. 31 illustrate user interfaces according to some example embodiments.

FIG. 32 is a block diagram showing an example point-of-sale system for conducting transactions over a network, according to some embodiments.

FIG. 33 is a block diagram illustrating a networked environment in which the described technology, according to some example embodiments, may be deployed.

FIG. 34 illustrates the training and use of a machine-learning program, according to some embodiments.

FIG. 35 illustrates a networked environment in which the described technology, according to some example embodiments, may be deployed.

FIG. 36 is a schematic diagram illustrating aspects of encryption, according to some examples.

FIG. 37 illustrates a block diagram of a software architecture, according to some example embodiments.

FIG. 38 illustrates a diagrammatic representation of a machine in the form of a computer system within which a set of instructions may be executed for causing the machine to perform any one or more of the methodologies discussed herein, according to an example embodiment.

### DETAILED DESCRIPTION

As mentioned above, creating, and managing subscription programs across many different tenants in a multi-tenant environment, each with their own systems and requirements, requires solving many technical challenges around integration, data management, and configuration. As is described further below, some examples facilitate payment for products and services, and subscriptions for products and services, using loans. In some instances, the loans are obtained from third parties. In some instances, financing opportunities (such as loans) are obtained, configured, and implemented in real time (or “on the fly”) during a check out flow. Some examples check out flows are provided below. Some payments for products, services and subscriptions are hybrid in the sense that they are financed part by loan, and part by cash and/or part by a redeemable value stored in a wallet.

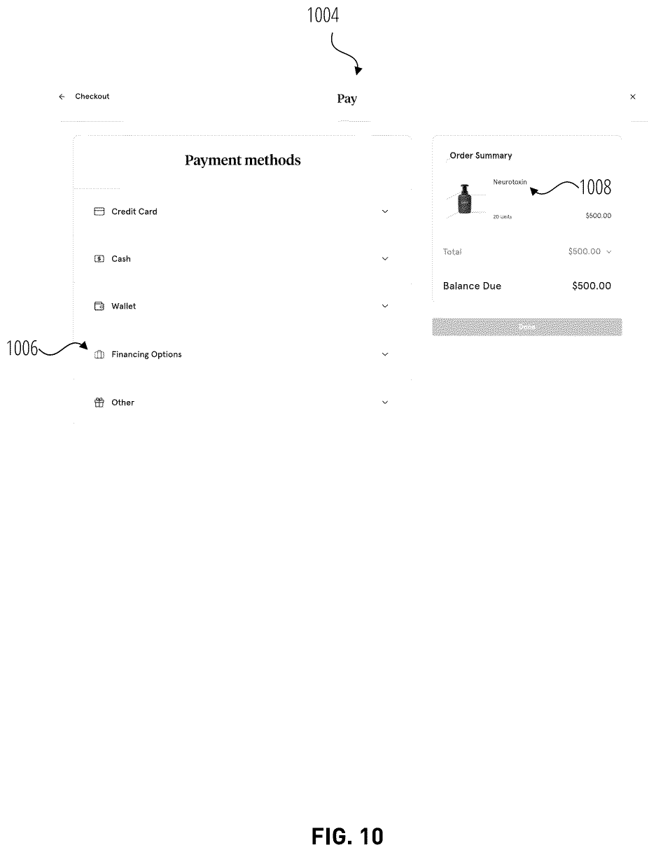

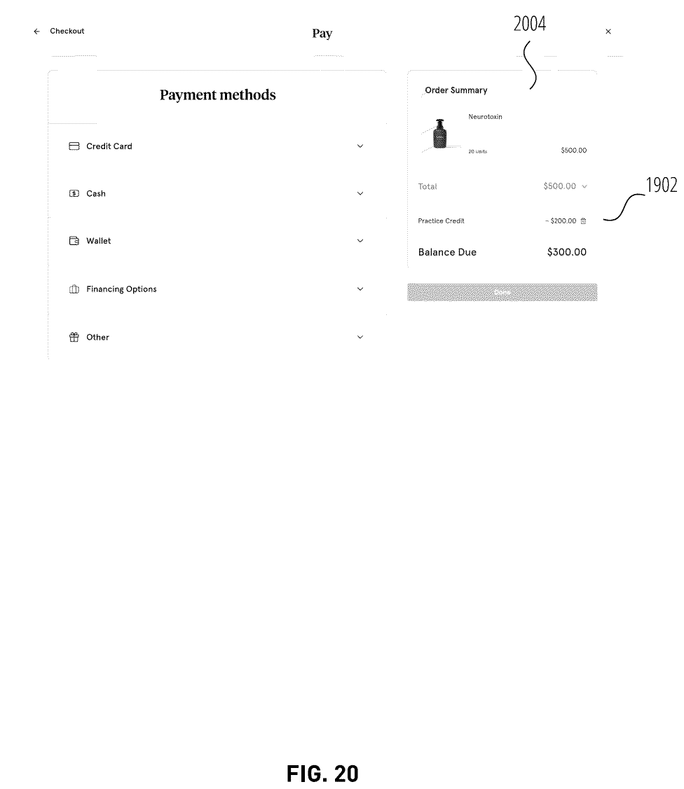

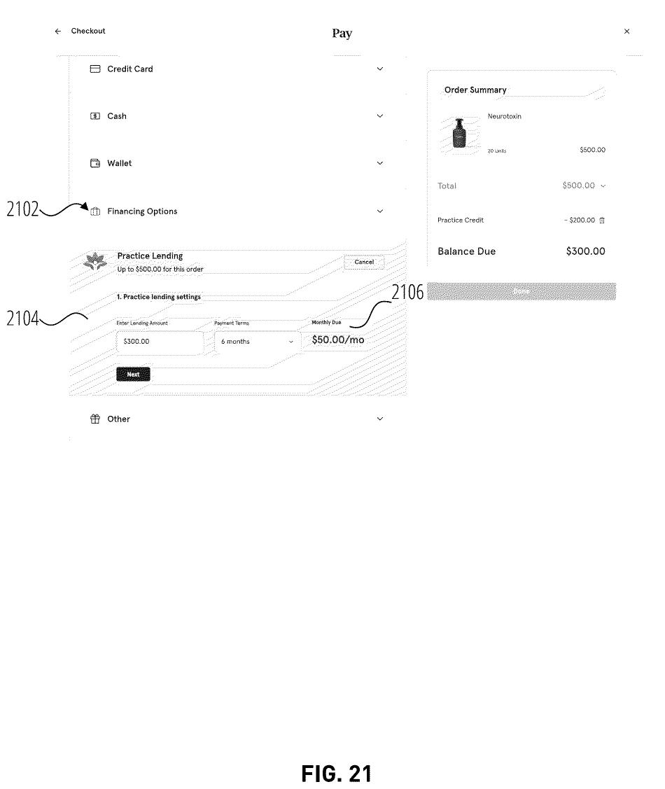

Despite technical challenges of the type described herein, some example systems of the present disclosure greatly simplify payment by patients for products, services, and subscriptions by characterizing, if an existing loan is in place, a first set of recurring payments made by a patient for a given product, service, or subscription as a set of loan repayments having the nature of a debt repayment. If the system determines that the loan has been repaid, a second set of recurring payments is characterized as a subscription payment having the nature of credit payments. A subscription or credit payment may be stored as a redeemable value in an online wallet, for example. The payment is redirected as a credit instead of being directed at the loan. In some examples, a stored redeemable value may be applied to pay for a product, service, or subscription during a checkout flow. Example check out flows are shown in FIG. 10-FIG. 31 and described further below.

From the perspective of a patient, for example, paying in recurring payments for a product, service, or subscription, a convenient payment or financing arrangement or program may be established that initially serves to pay off the loan (or debt instrument) and then seamlessly converts to a subscription payment automatically once the loan is paid off. To the patient, no difference in payment levels or frequency may be discerned, nor is a fresh subscription set up required. If a subscription is not desired, ongoing payments until canceled may conveniently be stored as a redeemable value in an online wallet, for example. The payment is redirected as a credit instead of being directed at the loan repayment. The patent interacts with and enjoys a seamless and convenient outward experience, but the underlying system nevertheless has the improved technical ability and functionality to handle the complex underlying technical, legal and financial difficulties and accounting rules. Examples of these technical difficulties are described further below.

In terms of system integration as an example technical problem, conventional systems that process loan repayments are often completely separate from subscription billing systems. Integrating these so that a loan payment can trigger a subscription charge is technically challenging. Loan servicing systems are often large, legacy systems not designed for real-time integration with other systems. They may lack modern APIs or ways to trigger events. Subscription billing systems are built for flexibility and integration, but may not have ability to handle loan-like features like principal balances, interest calculations, etc. Significant development work is required on both systems to build real-time integration between the two and migrate data.

In terms of variable payment amounts, loan repayments often vary month-to-month based on interest charges. Subscriptions typically have a fixed recurring charge. Allowing variable subscription amounts often require changes to the billing system. Loan repayments vary based on amortization schedule and interest accruals. Building ability to handle variable, dynamic pricing into subscription billing system is challenging. Changes to recurring subscription amounts often require manual overrides or customer consent. Automating variable pricing requires core billing system enhancements.

In terms of payment processing, loans and subscriptions often use different payment processors. Switching a payment method from one processor to another adds complexity. New payment profiles and merchant accounts need to be established. Customer payment information needs to be securely transferred between processing platforms. Ongoing payment processing is more complex if both loan and subscription payments used.

In terms of accounting changes, loans and subscriptions are accounted for differently. Converting a loan to a subscription requires updates to accounting practices. Loan principal and interest are accounted for differently than subscription revenue. Accounting rules for revenue recognition and deferred revenues would need to be updated. Tax treatment and reporting of payments may change.

There may also be tax implications, for example interest payments on loans are often tax deductible, while subscription fees usually are not. This could have tax implications that would need to be addressed. Deductibility of interest payments would need to be reviewed. Sales tax may newly apply to subscription payments in many jurisdictions. Tax reporting and documentation like 1098 forms may need to change.

Legal and regulatory requirements may also be invoked, for example there may be legal, regulatory, or contractual restrictions on converting loans to subscriptions that would need to be reviewed. Existing loan agreements may not allow converting to subscriptions. Stricter regulations apply to loans vs. subscriptions in many cases. Disclosures and documentation like Truth in Lending may need to be updated.

Improved customer experience though improved technical solutions is also a significant factor that present examples seek to address. The customer experience for loan repayments and subscriptions is conventionally quite different. The careful design of present examples makes this transition clear and understandable. Loan customers expect fixed-term payments and principal balances. Subscriptions are ongoing until cancelled. Customer service teams and the expert systems described herein need training to manage questions and potential confusion around changes. Through improved technology, example user interfaces herein reflect the new experience and provide convenience for transacting parties.

In some examples, a computer-implemented method executed on a computing device comprising a processor and memory for managing loans and subscriptions in a multi-tenant environment, the computer-implemented method comprising: in a first user session: receiving, via a first user interface element of a user interface, first order data relating to a first subscription offering, the first order data including a first set of attributes relating to the first subscription offering; incorporating the first order data into an encrypted subscription data structure stored in the memory, the encrypted subscription data structure including quantity data and period data for the first subscription offering; calculating, by the processor, a one-time payment amount for the first subscription offering based on the quantity data; calculating, by the processor, a periodic monthly subscription payment amount for the first subscription offering based on the quantity data and the period data; automatically communicating, by the processor, the one-time payment amount and periodic monthly subscription payment amount to a financial exchange system via an API; receiving a first financing offer under a first loan related to the first subscription offering; causing presentation of both the one-time payment amount and the periodic monthly subscription payment amount; causing presentation of the first financing offer in the first user interface element; based on a user acceptance of and access to the first loan, receiving a first payment via the user interface, for the one-time payment amount or the periodic monthly subscription payment amount; and processing the first payment in a check out flow in the first user session.

In some examples, the method further comprises in a second user session: receiving a second payment via the user interface; determining whether a payment under the first loan is due, or whether the first loan is paid off; based on a determination that a payment under the first loan is due, applying the second payment to the first loan by the processor; or based on a determination that the first loan is paid off, applying the second payment as a credit to a user account by the processor, or as payment for an item or service in a check out flow in the second user session; and processing the second payment by the processor and updating the encrypted subscription data structure.

In some examples, the credit is applied to a digital wallet associated with the user account.

In some examples, the method further comprises receiving a user request to access the digital wallet in a check out flow during the first or second user session.

In some examples, the method further comprises, in the first user session: receiving, via a second user interface element of the user interface, second order data related to a second subscription offering, the second order data including a second set of attributes related to the second subscription offering; incorporating the second order data into the encrypted subscription data structure, the encrypted subscription data structure including quantity data and period data for the second subscription offering; calculating a one-time payment amount and a periodic monthly subscription payment amount for the second subscription offering; automatically communicating the one-time payment amount and periodic monthly subscription payment amount for the second subscription offering to the financial exchange system via the API; receiving a second financing offer under a second loan related to the second subscription offering; causing presentation, in the second user interface element, of the one-time payment amount and the periodic monthly subscription payment amount for the second subscription offering; and causing presentation of the second financing offer in the second user interface element.

In some examples, the method further comprises presenting a toggle feature in the user interface to toggle between presentations of the first and second user interface elements.

In some examples, the method further comprises receiving third order data relating to a third offering, the third offering having a one-time payment option only, the method further comprising a presentation of a one-time payment amount related to the third offering.

In some examples, each of the first and second sets of attributes comprises an item identifier associated with at least one of an item or a service.

In some examples, each of the first and second set of attributes comprises a recurring attribute identifying the respective offering as being a recurring offering, and wherein the first and second order data is incorporated based on the recurring attribute.

In some examples, the financial exchange system provides financing options relating to the periodic monthly subscription payment amounts to financiers.

In some examples, the communication of the periodic monthly subscription payment amounts includes communicating further information pertaining to each of the first and second subscription offerings, the further information including identification information for a provider and consumer of the offerings.

In some examples, the first financing offer and second financing offer comprise financing terms, the method further including communicating the financing offers from the financial exchange system to be presented via the user interface.

In some examples, the financing offers include a first financing offer pertaining to the first subscription offering and a second financing offer pertaining to the second subscription offering.

In some examples, predefined business rules are applied to selectively present at least one of the first or second financing offers via the user interface.

In some examples, a computing system for managing loans and subscriptions comprises: a multi-tenant server executing a loan and subscription management platform and having a processor and memory storing instructions; a client device including a user interface, the client device communicatively coupled to the multi-tenant server; wherein the instructions, when executed by the processor, cause the multi-tenant server to perform operations comprising at least: in a first user session: receiving, via a first user interface element of a user interface, first order data relating to a first subscription offering, the first order data including a first set of attributes relating to the first subscription offering; incorporating the first order data into an encrypted subscription data structure stored in the memory, the encrypted subscription data structure including quantity data and period data for the first subscription offering; calculating, by the processor, a one-time payment amount for the first subscription offering based on the quantity data; calculating, by the processor, a periodic monthly subscription payment amount for the first subscription offering based on the quantity data and the period data; automatically communicating, by the processor, the one-time payment amount and periodic monthly subscription payment amount to a financial exchange system via an API; receiving a first financing offer under a first loan related to the first subscription offering; causing presentation of both the one-time payment amount and the periodic monthly subscription payment amount; causing presentation of the first financing offer in the first user interface element; based on a user acceptance of and access to the first loan, receiving a first payment via the user interface, for the one-time payment amount or the periodic monthly subscription payment amount; and processing the first payment in a check out flow in the first user session.

In some examples, the operations further comprise: in a second user session: receiving a second payment via the user interface; determining whether a payment under the first loan is due, or whether the first loan is paid off; based on a determination that a payment under the first loan is due, applying the second payment to the first loan by the processor; or based on a determination that the first loan is paid off, applying the second payment as a credit to a user account by the processor, or as payment for an item or service in a check out flow in the second user session; and processing the second payment by the processor and updating the encrypted subscription data structure.

In some examples, the credit is applied to a digital wallet associated with the user account.

In some examples, the operations further comprise processing a user request to access the digital wallet in a check out flow during the first or second user session.

In some examples, the instructions further cause the multi-tenant server to: receive, via a second user interface element of the user interface, second order data related to a second subscription offering, the second order data including a second set of attributes related to the second subscription offering; incorporate the second order data into the encrypted subscription data structure, the encrypted subscription data structure including quantity data and period data for the second subscription offering; calculate a one-time payment amount and a periodic monthly subscription payment amount for the second subscription offering; automatically communicate the one-time payment amount and periodic monthly subscription payment amount for the second subscription offering to the financial exchange system via the API; receive a second financing offer under a second loan related to the second subscription offering; cause presentation, in the second user interface element, of the one-time payment amount and the periodic monthly subscription payment amount for the second subscription offering; and cause presentation of the second financing offer in the second user interface element.

In some examples, the instructions further cause the multi-tenant server to present a toggle feature in the user interface to toggle between presentations of the first and second user interface elements.

In some examples, the instructions further cause the multi-tenant server to receive third order data relating to a third offering, the third offering having a one-time payment option only, and present the one-time payment amount related to the third offering.

In some examples, each of the first and second sets of attributes comprises an item identifier associated with at least one of an item or a service.

In some examples, each of the first and second set of attributes comprises a recurring attribute identifying the respective offering as being a recurring offering, and wherein the first and second order data is incorporated based on the recurring attribute.

In some examples, the financial exchange system provides financing options relating to the periodic monthly subscription payment amounts to financiers.

In some examples, the communication of the periodic monthly subscription payment amounts includes communicating further information pertaining to each of the first and second subscription offerings, the further information including identification information for a provider and consumer of the offerings.

In some examples, the first financing offer and second financing offer comprise financing terms, and wherein the financing offers are communicated from the financial exchange system to be presented via the user interface.

In some examples, the financing offers include a first financing offer pertaining to the first subscription offering and a second financing offer pertaining to the second subscription offering.

In some examples, predefined business rules are applied to selectively present at least one of the first or second financing offers via the user interface.

In some examples, a non-transitory computer-readable storage medium includes instructions that when executed by a computer, cause the computer to perform operations comprising at least: in a first user session: receiving, via a first user interface element of a user interface, first order data relating to a first subscription offering, the first order data including a first set of attributes relating to the first subscription offering; incorporating the first order data into an encrypted subscription data structure stored in the memory, the encrypted subscription data structure including quantity data and period data for the first subscription offering; calculating, by the processor, a one-time payment amount for the first subscription offering based on the quantity data; calculating, by the processor, a periodic monthly subscription payment amount for the first subscription offering based on the quantity data and the period data; automatically communicating, by the processor, the one-time payment amount and periodic monthly subscription payment amount to a financial exchange system via an API; receiving a first financing offer under a first loan related to the first subscription offering; causing presentation of both the one-time payment amount and the periodic monthly subscription payment amount; causing presentation of the first financing offer in the first user interface element; based on a user acceptance of and access to the first loan, receiving a first payment via the user interface, for the one-time payment amount or the periodic monthly subscription payment amount; and processing the first payment in a check out flow in the first user session.

In some examples, the operations further comprise: in a second user session: receiving a second payment via the user interface; determining whether a payment under the first loan is due, or whether the first loan is paid off; based on a determination that a payment under the first loan is due, applying the second payment to the first loan by the processor; or based on a determination that the first loan is paid off, applying the second payment as a credit to a user account by the processor, or as payment for an item or service in a check out flow in the second user session; and processing the second payment by the processor and updating the encrypted subscription data structure.

Such examples can provide solutions for technical problems because creating and managing loan and subscription programs across many different tenants, each with their own systems and requirements, requires solving many technical challenges around integration, data management, and configuration. Examples described herein address these challenges by providing a loan and subscription management system that can be configured for each tenant's needs.

Allowing each tenant to have a unique loan and subscription program requires a technical solution that can be flexibly configured and customized for each tenant. The inventive subject matter solves this by allowing each tenant or patient to provide order data (first and second order data, and so forth) to configure their specific loan and/or subscription program.

Providing an interface that is fast and easy to use requires solving technical challenges around user experience design and system performance. The inventive subject matter addresses this by providing in some examples a touchscreen tablet device and allowing a platform user (e.g., a tenant practice or a tenant patient) to configure the loan and subscription program while watching.

Executing loan and subscription programs in real-time during payment transactions requires technical solutions by integrating an interactive platform with payment processing systems and calculating aspects such a subscription fees, loan fees and interest rates, integration with third party platforms and finance companies, and calculating loyalty rewards, on-the-fly. The inventive subject matter addresses these issues by operating in some examples in conjunction with or as part of a payment facilitator. In summary, the inventive examples described herein can address and seek to solve these technical problems by providing a multi-tenant loan and subscription management system including an interactive platform that can be configured for each tenant's needs, allows flexible customization of each tenant's program, uses an easy-to-use touchscreen interface, and integrates with payment processing to execute loan and subscription programs in real-time. The examples thereby enable the creation and management of unique loan and subscription programs for many different tenants with technical ease.

According to some further example embodiments, there is provided a loan and subscription management system that generates and uses data structures and interfaces that allow for configurability and flexibility in the creation of a bundle of subscriptions, for a specific consumer, to one or more products or services, which may be delivered in terms of one or more plans. Payment for the bundle of subscriptions, products or services may be made using a card present or card not present transaction.

Each subscription within a bundle of subscriptions can be for a product or service and has a fulfillment price. Further, each subscription has a period in which it may reoccur (e.g., one month, six months, one year, etc.). These recurrence periods may perpetuate indefinitely or may terminate after a set number of occurrences (or cycles).

Each subscription can furthermore be financed by a loan from a third party, or by a service provider. Alternatively, a consumer can pay the full amount for a subscription at one time (e.g., upon initiation of the subscription). The terms of the subscription (both delivery and financial) can be dynamically managed by consumers in some cases (e.g., a consumer may be able to change the period over which the subscription may reoccur).

Even further, each subscription may be executed independently of other subscriptions in a bundle, while billing for one or more subscriptions within the bundle may be aggregated into a single payment once a month (or on some other periodic basis). Service plans may, in some embodiments, be made with the assistance of a service delivery expert (e.g., a physician), and may be fulfilled at a place of business of the expert (e.g., a medical practice office of the physician). Product fulfillment, on the other hand, may be performed by shipment.

As noted above, each subscription in a bundle may be financed by a loan from a third party or service provider. In one embodiment, loans may be facilitated in real time. To this end, a loan and subscription management system communicates details of a particular subscription to a financial exchange in near real-time. The details of a particular description include, for example, identification of the products or services being offered, details of the provider, and details of the consumer. Third-party financiers may access the financial exchange, again in near real-time, to accept any number (or none) of the subscriptions being offered via the financial exchange.

In one embodiment, the receipt of subscription details, the offering of subscription financing opportunities to third-party financiers, and the receipt of acceptance/decline of a financing opportunity (such as the issuing of a loan) may occur in near real-time, and while a customer is standing at the checkout counter of a service consumer.

Defining the quantity and frequency of delivery of a product or service offering under subscription plan is tricky and presents technical challenges to a user. This is particularly so where the product or service offering is being subscribed to is part of a bundle of offerings or services included within a single subscription plan. For example, defining the quantity and frequency of delivery requires typing numerical data into appropriate fields and then calculating variables to display a monthly cost (or payment total) of the subscription plan. Because this area of the software is frequently used on a touchscreen tablet device while the customer is watching, now there is a need to have a fast friction free device to enter the data.

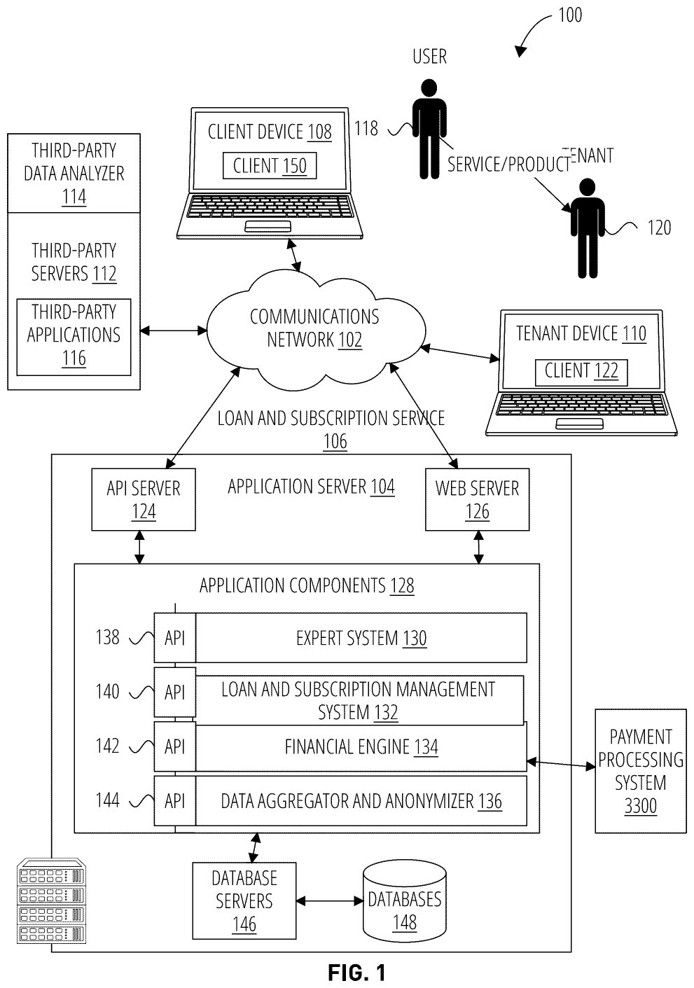

FIG. 1 illustrates a multi-tenant network 100 in which a communications network 102 communicatively couples application servers 104 at a loan and subscription service 106, a client device 108, a tenant device 110 (for example a point-of-sale tenant device 110), and third-party servers 112. The third-party servers 112 may be accessed and operated by a third-party data analyzer 114 (e.g., a “big data” company), for example. The third-party servers 112 host third-party applications 116.

In some examples, the loan and subscription service 106 operates as a core system in the form of a multi-tenant platform that allows each tenant 120 (e.g. medical practice) to configure unique loan and subscription programs for their patients. The loan and subscription service 106 includes a web interface and APIs as described below to allow setup and integration with other systems. Databases and tenant data segregation manage data for different tenants. The loan and subscription service 106 includes one or more user portals described further below that provide an overview of loans, subscriptions, and payments. The user portals allows self-service management of subscriptions and loans, and clearly explain transitions from loans to subscriptions.

By combining configurable platform, optimized interfaces, payment integration, accounting automation, and customer transparency, the technical components can achieve the goals of flexible, integrated, automated loan and subscription management.

The client device 108 is accessed by a user 118 (e.g., a patient) and processes operations and applications (e.g., a browser application, or commercial platform) sourced from or associated with a tenant 120. Where applicable in context, the user 118 may also be referred to as a client, a customer, a consumer, or a tenant patient in some examples herein. Where applicable in context, the tenant 120 may also be referred to as a service provider, a medical practice, or a tenant practice, in some examples herein. A tenant practice may for example operate in a group of networked tenant practices in a multi-tenant network 100. The user 118 may be a tenant patient of the tenant practice, for example. The tenant device 110 is accessed and operated by the tenant 120 to host and process tenant operations and tenant applications 122. In some examples, the multi-tenant network 100 includes a great multiplicity of tenants 120, each communicatively coupled with the loan and subscription service 106.

In some examples, the client device 108 and the tenant device 110 include a tablet or kiosk with a touchscreen allowing easy configuration of programs and purchases by a user 118 and a tenant 120, respectively. The client device 108 and the tenant device 110 connect to the multi-tenant platform (loan and subscription service 106) to capture use and tenant specific configurations. The interface is designed for simplicity and speed to optimize user experience.

The application servers 104 include an API server 124 and a web server 126 which, in turn, facilitate access to several application components 128 that include an expert system 130, a loan and subscription management system 132, a financial engine 134, and a data aggregator and anonymizer 136. Each of these components is provided with a respective API, namely an API 138, an API 140, an API 142, and an API 144.

The application components 128 are communicatively coupled to database servers 146 which in turn facilitate access to one or more databases 148.

In an example scenario, a tenant 120 (e.g., a medical practice) may wish to provide offerings (e.g., products or services) to a user 118 (e.g., a patient of the medical practice), either as a once-off/one-time delivery or as part of a subscription plan which has a recurrence. In this example, the medical practice, i.e., tenant 120, may also wish to provide the patient, i.e., user 118 with the option of paying for a health product or consultation as a once-off payment, as a subscription payment, or as a combination of a once off payment and a subscription payment.

At a high level, the expert system 130 operates to enable an expert in a particular vertical (e.g., the medical practice or tenant 120) to its patients or users 118. An expert system 130 is accordingly specifically constructed and programmed for the creation of a plan for the delivery of a specific product or service in a particular product or service vertical. The expert system 130 may also assist to define and manage a licensing plan for a tenant 120 involving a tenant-configurable practice license fee based on a selection of a number of invokable tenant-selectable features of an interaction platform described further below.

The loan and subscription management system 132 is responsible for the automated management of a plan (which may or may not include any number of subscriptions to products or services, or licensing fees).

The financial engine 134 is responsible for communicating financing opportunities related to a plan to one or more financiers (e.g., who may operate as a provider, or who may be a third party accessing the financial engine 134 via the third-party applications 116).

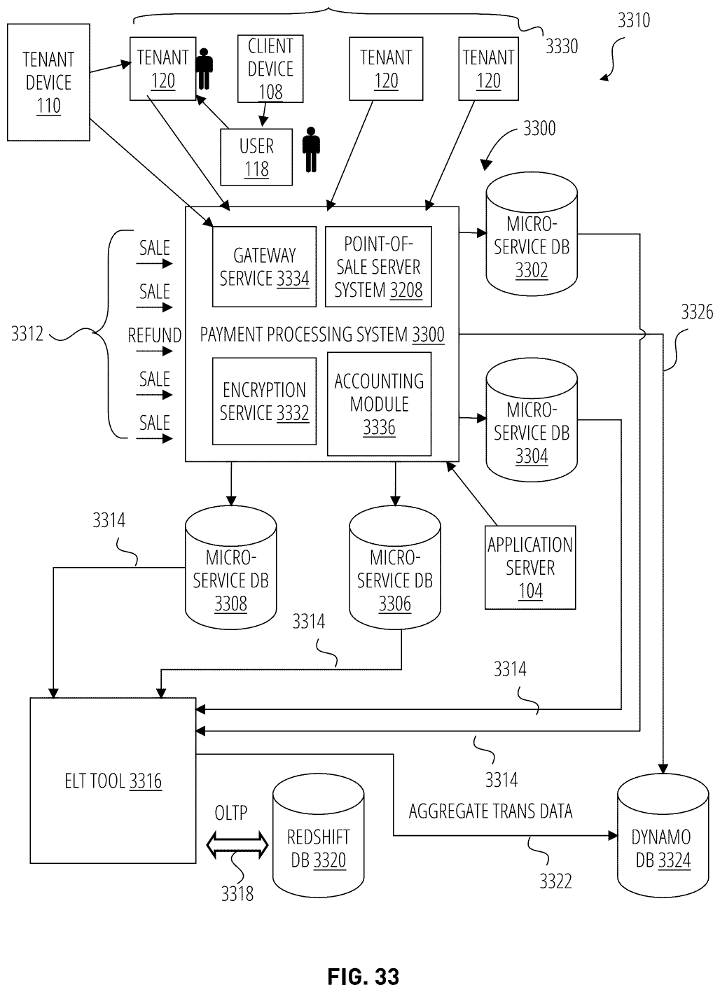

In some examples, the financial engine 134 includes or is connected to a payment processing system 3300 discussed further below in relation to FIG. 33. The payment processing system 3300 includes an accounting module 3336 (FIG. 33). For the hybrid loan and subscription models provided by the loan and subscription service 106, the accounting module 3336 handles accounting treatment of loans, subscriptions, payments, and revenue recognition. It integrates with accounting systems to manage deferred revenue, principal balances, and so forth. The accounting module 3336 automates accounting process and compliance.

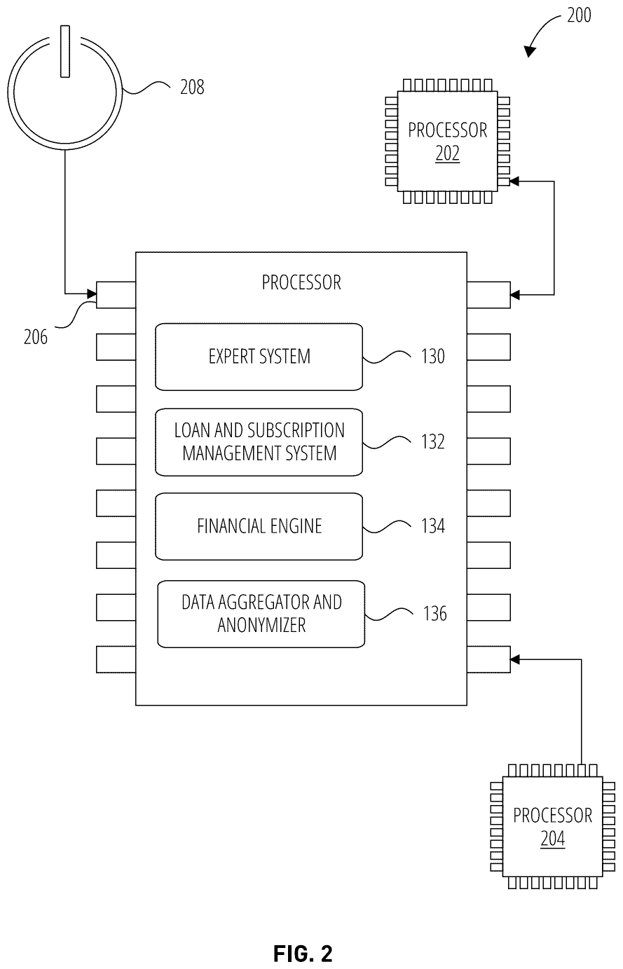

FIG. 2 is a diagrammatic representation of a processing environment 200, which includes a processor 202, a processor 204, and a processor 206 (e.g., a GPU, CPU, or combination thereof). The processor 206 is shown to be coupled to a power source 208, and to include (either permanently configured or temporarily instantiated) modules, namely the expert system 130, the loan and subscription management system 132, the financial engine 134, and the data aggregator and anonymizer 136. The expert system 130 operationally supports a guided process for the selection of products or services, as well as the attributes of such products and services (e.g., quantity (units), a frequency of delivery and number of deliveries), to include in a subscription.

The loan and subscription management system 132 operationally calculates and presents information relating to overall options related to a loan and/or a subscription for a bundled purchase, for example.

The financial engine 134 operationally allows third parties (e.g., lenders) to view financing opportunities and accept or reject such financing opportunities for subscriptions (or bundles of subscriptions) and license fees generated by the loan and subscription management system 132.

As illustrated, the processor 206 is communicatively coupled to both the processor 202 and processor 204 and receives data from the processor 202, as well as data from the processor 204. Each of the processor 206, processor 202, and processor 204 may host one or more of an expert system 130, a loan and subscription management system 132, a financial engine 134, and a data aggregator and anonymizer 136.

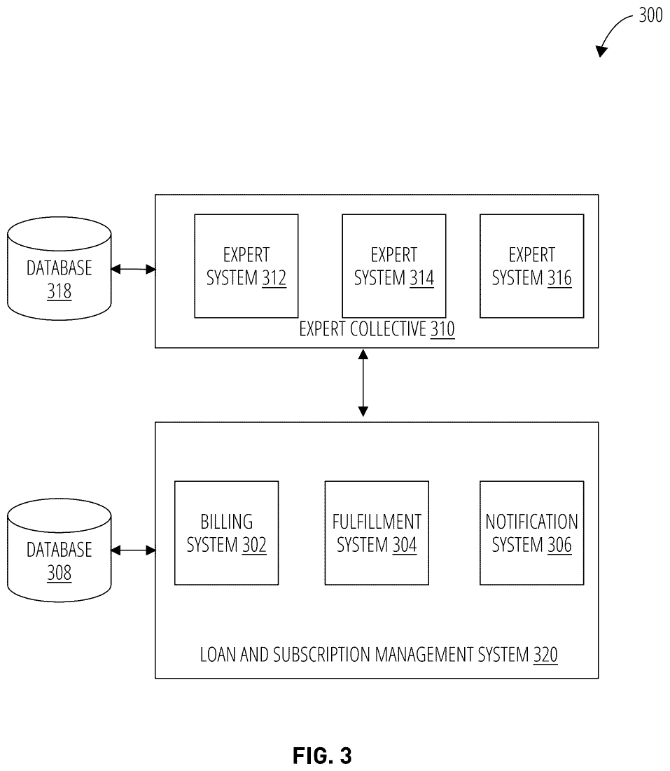

FIG. 3 illustrates in one layer various sub-components of a loan and subscription management system 320, namely a billing system 302, a fulfillment system 304, and a notification system 306.

The billing system 302 is operationally responsible for the processing of payments and issuing of invoices/bills. The billing system 302 may operate in conjunction with the payment processing system 3300, and in particular the accounting module 3336.

The fulfillment system 304 communicates with third parties for the shipping of goods, when appropriate, as well as with service providers to record the delivery of goods and services to a customer. The notification system 306 operationally provides notifications to both customers and service providers regarding upcoming fulfillment events, as well as other delivery-related events.

The loan and subscription management system 320 is also communicatively coupled to a database 308 to both store and retrieve data needed by each of the billing system 302, the fulfillment system 304 and the notification system 306. The fulfillment system 304 creates and tracks the fulfillment or delivery of a service or a product. For example, for a service, the fulfillment system 304 records what was rendered or provided (e.g., what, how much, when, value) and uses the notification system 306 to remind users of appointments for a follow-up service. For products, the fulfillment system 304 issues orders, tracks shipping and delivery, in addition to tracking what was rendered and provided.

The notification system 306 is a messaging system that uses different media or messaging channels (e.g., email, text, push notification, etc.) to alert customers, providers (e.g., practices) and operations of different events.

FIG. 3 also illustrates that a loan and subscription management system 320 may include in another layer an expert collective 310 comprising respective and distinct expert systems, namely an expert system 312, an expert system 314 and an expert system 316. Each of the expert systems may be dedicated to a specific vertical and provide a guided process for the creation of license fees for tenants, and subscriptions and plans for patients in that vertical. For example, the expert system 312 may be dedicated to a cosmetics and beauty care vertical, the expert system 314 may be dedicated to a treatment vertical, and the expert system 316 may be dedicated to a nutrition vertical. Each of the expert systems within the expert collective 310 may furthermore communicatively coupled, and have access, to a respective database 318.

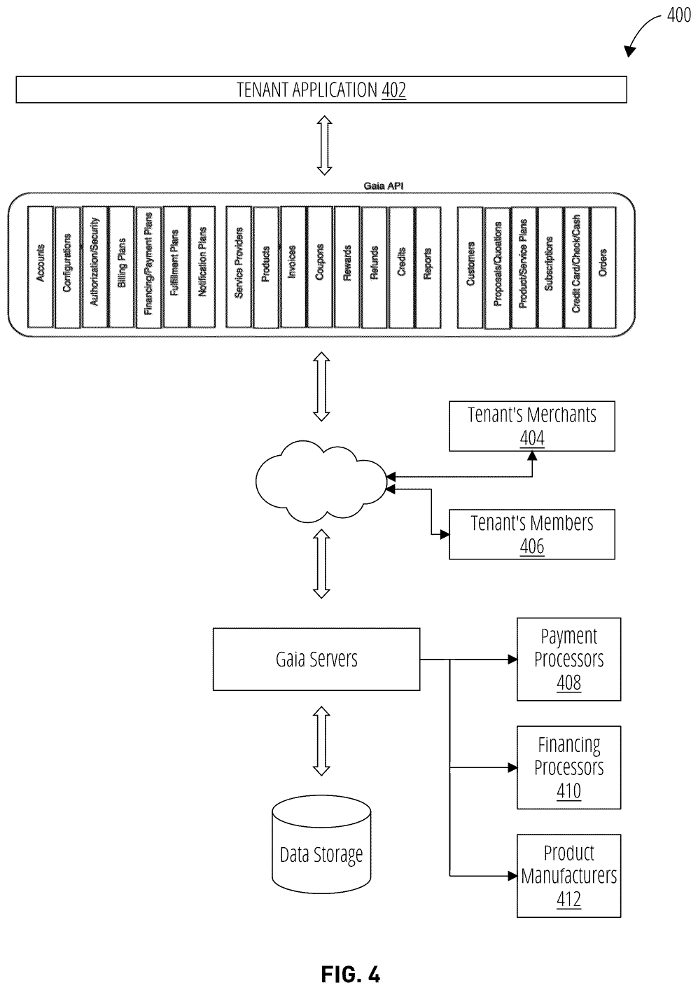

FIG. 4 is a block diagram illustrating a loan and subscription management system 400 and shows further details for a specific example embodiment. The loan and subscription management system 400 includes a tenant application 402 that, via the API server 124 and the communications network 102, accesses the application component 128. The API server 124 is shown to support many functions provided by the application component 128, using data store to and retrieved from the database 148.

The tenant application 402, via the API server 124 and the communications network 102, is also able to access tenant's merchant 404 and tenant's member 406. The application component 128 is also shown to exchange information and data with payment processors 408, financing processors 410 and product manufacturers 412.

The loan and subscription management system 400 is, in one example embodiment, a cloud-based e-commerce solution or platform built for developers to streamline and shorten the time to market of any e-commerce system that implements a variety of tenant licensing fees and arrangements, subscription models, quotations, recurring billings, electronic payments, order financing, order fulfillment, loyalty program, and notifications. The loan and subscription management system 400 provides a rich set application programming interface (API) for developers to seamlessly integrate with their own systems. Modules and their APIs that developers can use to customize the loan and subscription management system 400 to meet their own needs are as follows:
Accounts: primary account management and authorization.
Billing Plans: billing plan cycle options.
Financing/Payment Plans: members payments and financing options.
Fulfillment Plans: order fulfillment process.
Notification Plans: upcoming product/service notifications.
Service Providers: service providers information and configurations.
Products: products/services configuration.
Invoices: members' invoices and invoice line items.
Refunds: members' refunds management.
Credits: members' credits management.
Reports: analytical data on membership, financials, etc.
Coupons: coupons management.
Rewards: loyalty reward program for membership.
Customers: members management.
Product/service Plans: members' product/service plans management.
Proposals/Quotations: proposals and quotations.
Subscriptions: members' subscription configuration and management.
Credit Card/Check/Cash: member's credit card/check/and cash management.
Sample Data FlowRegister a business account with the loan and subscription management system 400.
AccountResponse account=createAccount(AccountRequest request)Creates a treatment plan for members that all subscribed services are paid on the same date, the same invoice on a monthly basis.
BillingPlanResponse billingPlan=createBillingPlan(BillingPlanRequest request)Create a one-time payment plan for its subscribers.
PaymentPlanResponse paymentPlan=createPaymentPlan(PaymentPlanRequest request)Create a recurring payment plan for its subscribers.Request Ex:{“name: “Monthly Payment”, payment_gateway: gateway_id, payment_count: 0, . . . });
Create some fulfillment plans (1 month, 2 month, . . . , 12 months) for providers to useFulfillmentPlanResponse fulfillmentPlan1=createFulfillmentPlan(FulfillmentPlanRequest request)
Create some notification plans for providers to use for any subscription's order.
NotificationPlanResponse notificationPlan1=createNotificationPlan(NotificationPlanRequest request)
Create a providerProviderResponse response=API.createProvider(new ProviderRequest( ))
Create coupons from own product catalog for its members.
CouponRequest=new CouponRequest(Create products for its members.
ProductResponse product=createProduct(ProductRequest request)
Registers a new memberCustomerResponse customerResponse=API.createCustomer(customerRequest);
Add CC to a member
CardResponse=API.createCard(cardRequest); String cardId=cardResponse.apiData.card.getCardId( );
Create a treatment plan for a member.
SubscriptionPlanResponse=API.createSubscriptionPlan(subscriptionPlanRequest);
Create different subscriptions for a member.
SubscriptionResponse=API.createSubscription(subscriptionRequest);
Get pending Invoice of a subscription plan.
InvoiceResponse=APIlistInvoices(invoiceRequest); Charge a pending invoice of a subscription plan (Transaction)
TransactionResponse=API.chargeInvoice(transactionRequest);
Get member's upcoming order fulfillment under a subscription planorder list=list_order({“subscription_plan_id”: “pla_9473c93”, “filter”: “pending” })
Updateexpert updates member's order fulfillment; i.e. confirmed, fulfilled, etc.status=update_order({“order_id”: “or_9473c93”, “status”: “completed” }

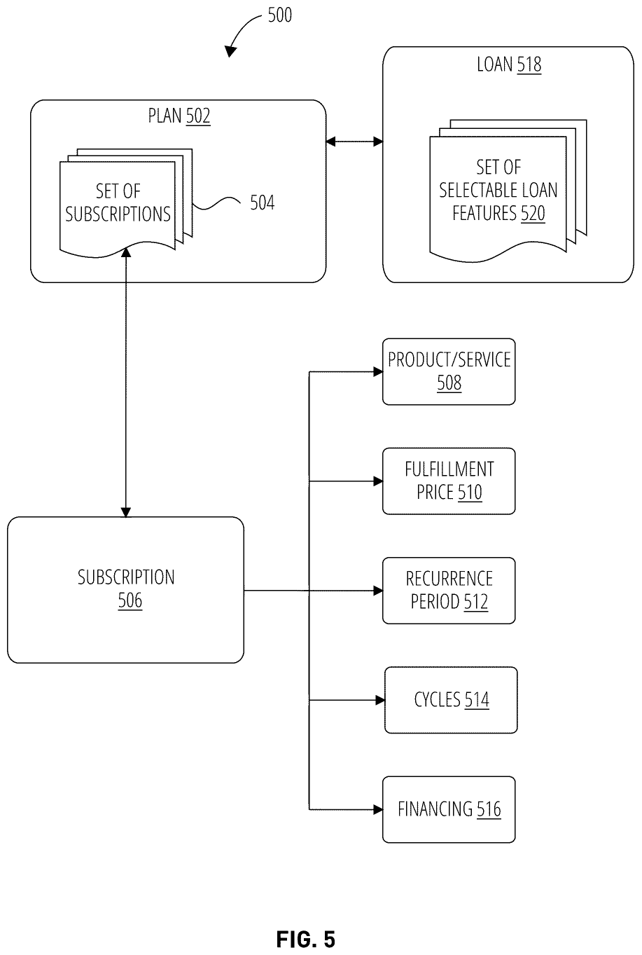

FIG. 5 is a diagrammatic representation of a data architecture 500 created using and maintained by the loan and subscription management system 320. A plan 502 includes a set of subscriptions 504. Each subscription 506 of the set of subscriptions 504 is for a product or service and has several attributes, a subset of which is shown in FIG. 5. Specifically, each subscription 506 relates to a specific product/service 508, has a fulfillment price 510, and a recurrence period 512. With respect to the recurrence period 512, a subscription 506 has some time period after which the subscription 506 recurs, e.g., must again be fulfilled. A subscription 506 may furthermore have a specified number of cycles 514 and may occur indefinitely or terminate after the specified number of the cycles 514.

A subscription 506 furthermore has associated financing 516. A subscription 506 may be financed via a loan or via a service provider directly as part of the service provider's subscription business. Alternatively, a subscription 506 may be fulfilled at a time of ordering.

Attributes of the subscription 506 may be managed by customers (such as a user 118, as a patient of a tenant 120 operating as a medical practice, for example) in some cases. For example, the cycles 514 may be modified or changed by a customer using the client 150 in order to interact with the loan and subscription management system 320.

A specific subscription 506 may furthermore be executed independently of any other subscriptions included in a set of subscriptions 504, with the exception that billing is aggregated to a single payment at predetermined intervals (e.g., once a month).

A plan 502 may also include a loan 518 based on a set of selectable loan features 520 selected by a tenant 120 using the loan and subscription management system 132 or loan and subscription management system 320 in a multi-tenant network 100.

A plan 502 for the delivery of service may be constructed or defined with the help of an expert (e.g., a physician or doctor) using an appropriate expert system 312, and performance/delivery of a subscription 506 of the plan 502 may be fulfilled at the expert's place of business (e.g., the doctors practice). A plan 502 for the delivery of a product may be fulfilled by shipment from a third party.

To facilitate financing (e.g., a loan as part of the financing 516) in near real-time, the loan and subscription management system 320 is communicatively coupled to the financial engine 134 to enable the loan and subscription management system 320 digitally to communicate details about a particular subscription 506 or set of subscriptions 504 or a loan 518 or set of selectable loan features 520 to the financial engine 134. Financiers then access the financial engine 134 (e.g., using a third-party application 116) to optionally accept a financing offer relating to a particular product or service, or a set of subscriptions 504 or a subscription 506, or a loan 518 or a set of selectable loan features 520.

This facilitation of financing by a financier happens in near real-time for a tenant 120 or user 118. In a typical scenario, a customer is physically present at the checkout counter of a service provider. To this end, the financial engine 134 operationally aggregates accepted financing and rates, refusals and regular recurring subscriptions amounts to create a quote for a total monthly price for all subscriptions within a set of subscriptions 504. Examples of real-time check out flows are provided further below.

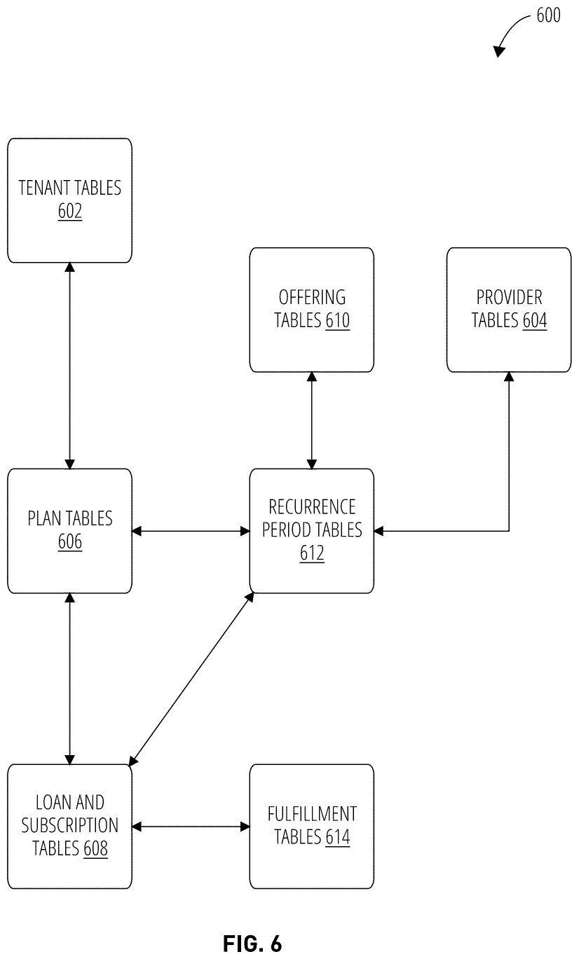

FIG. 6 is a block diagram illustrating a data architecture 600, according to some example embodiments. The data architecture 600 is realized and stored within the database 148. Tenant tables 602 store records for customers (e.g., the consumer or user 118) of various service providers, each service provider, in turn, being recorded within provider tables 604. A customer record within the tenant tables 602 may be associated with a plan 502 for which a record exists within plan tables 606. Each plan 502 within the plan tables 606 may be associated with a set of subscriptions 504, records for which exist within the loan and subscription tables 608. Offering tables 610 maintain records for each product/service 508 (as examples of offerings), and each subscription 506 has a specified cycle 514 within recurrence period tables 612. A fulfillment price 510 associated with a particular subscription 506 is also stored within respective records of the recurrence period tables 612. Fulfillment records (e.g., indicating and recording whether a particular subscription 506 has been fulfilled) are stored within fulfillment tables 614.

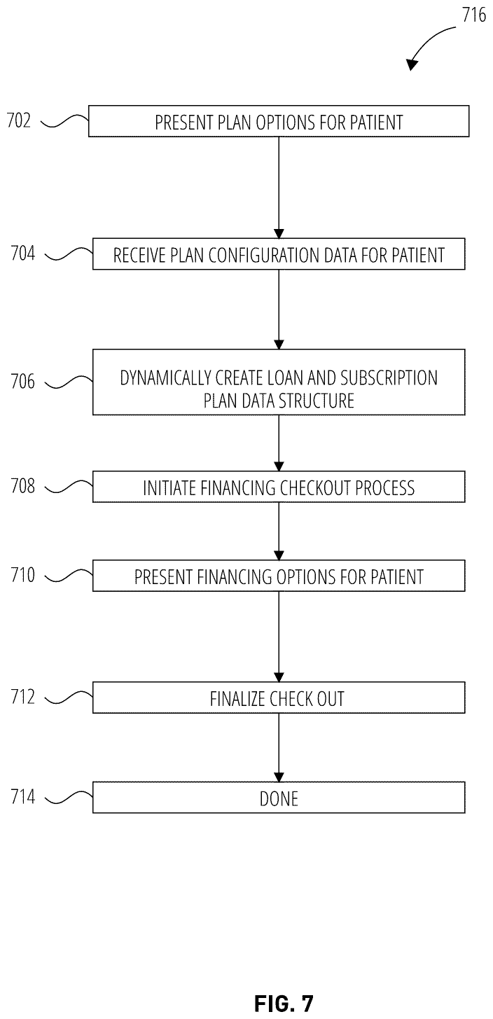

FIG. 7 is a flowchart illustrating a method 716, according to some example embodiments, to create a loan and subscription plan data structure and to facilitate financing of the subscription plan reflected in the data structure. Although the described flow diagram below can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

The method 716 commences at operation 702 with the presentation of plan options to a user 118, such as a patient. In one embodiment, the presentation may be made via user interfaces on which an expert (e.g., a cosmetic physician) and the patient collaborate. The presentation may accordingly be done via interfaces that are generated and communicated from an appropriate expert system 124, via a web server 122, to a client device 108 being operated by the expert. FIG. 10-FIG. 31 illustrate examples of such user interfaces.

At operation 704, the loan and subscription management system 128 receives plan configuration data from the expert system 124, the plan configuration data having been received from the patient at operation 704 1104 and in response to the presentation of plan options at operation 702. The plan configuration data, in some example embodiments, include the data described above.

At operation 706, the loan and subscription management system 128 proceeds to create a loan and subscription plan data structure automatically and dynamically, such as that described above.

At operation 708, the loan and subscription management system 128 initiates a financing checkout process by communicating pertinent details of a particular plan 502 of the financial exchange 130. Specifically, the loan and subscription management system 128 provides the following information to the financial exchange 130:

Information about the service provider (e.g., a medical practice) that provides the services; information about the patient (e.g., personal information such as a Social Security number (SSN) or driver's license number (DLN)) and financial history summary of the financial relationship between the customer and the service provider (e.g., including a financial history rating based on experience); and details of the plan including an array of subscriptions.

The financial exchange 130 responds with a number of financing offers containing: a list of subscriptions in the offer; and terms for the offer (e.g., interest rate, pay-off time, down payment, other financing items). The loan and subscription management system 128 will consider these and pick zero or more to offer the customer using pre-defined business rules. These business rules may specify, as follows: finance everything or nothing; prefer fewer offers; prefer lower offers; and provider finances unclaimed subscriptions.

The financing checkout process is facilitated in real time as a patient may be physically present at the location of an expert (e.g., a physician). As described above, the financial exchange 130 then presents financing options to potential financiers (e.g., various third parties or to the expert or service provider), to enable real-time decision-making by the potential financiers.

At operation 710, the financial exchange 130, having received acceptances or rejections of financing offers from the potential financiers, communicates these financing options back to the loan and subscription management system 128, which in turn presents them, via the expert system 124 to the patient. The patient, at operation 712, then elects to accept or reject the financing offers and finalizes the checkout process. The operation 712 is completed at operation 714.

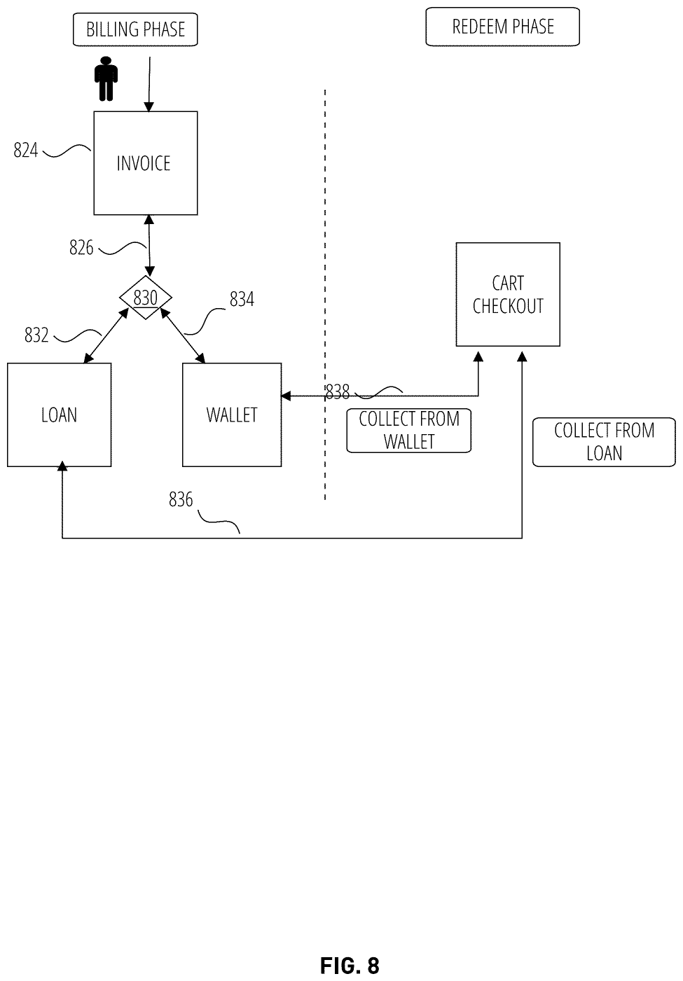

FIG. 8 depicts example operations in an online or attended in-person transactions for an item or service as the subject of a subscription offering. The item or service may be offered or recommended to a user such as a patient by an expert as described further above. The expert may operate in or as a medical practice as a tenant in a multi-tenant network, for example. The transactions may include a billing phase and a redeem phase, as shown. These phases may be separated in time, or into first and second user sessions. The billing and redeem phases may be performed by a client device in communication with a multi-tenant server executing a loan and subscription management platform and having a processor and memory storing instructions. The client device includes a user interface displaying interactive user interface elements.

At operation 824, in the billing phase, an invoice for the item or service (or first subscription offering) is presented to the patient in the client device interface. At operation 826, a payment is received. The patient has an option to pay the invoice directly out of personal funds, for example as shown in the check flows described further below. In other examples, the multi-tenant server determines, at decision 830, whether the patient has a loan repayment due (for example under a first loan) and directs the received payment as a loan repayment 832 accordingly. If a loan repayment is not due, the multi-tenant server applies the received payment as a credit 834 into a wallet for example associated with a user account of the patient at the medical practice. Thus, at the termination or pay off of a loan, the multi-tenant server can conveniently direct or convert ongoing or recurring payments received from a patient from a loan repayment into a credit payment or wallet receipt for redemption at a later time. The credit payments or wallet receipts may be regarded as, or applied to, ongoing “subscription payments” (and not “loan repayments”) in some examples, and characterized accordingly. This “conversion” of ongoing payments can facilitate the automatic accounting treatment of loan payments (“debt” payments) as opposed to wallet receipts (“credit” payments). The automatic accounting treatment of both types of transaction during and after expiry of a loan is handled by an accounting module 3336 described further below, in some examples.

In the redemption phase, which may be in a subsequent user session involving the same or a different item or service (or subscription offering) the patient can elect, via the user interface of the client device, to pay for that item or service (or subscription offering) from funds available under the loan at operation 836, or from a credit in the wallet at operation 838. The credit in the wallet applied in the redemption phase may be the same as or supplemented by the prior credit referred to just above i.e. received as a recurring payment “converted” from an ongoing loan repayment into a subscription payment. Based on the received payment election, the multi-tenant server is instructed to collect funds from the patient's loan, or the patient's digital wallet, accordingly.

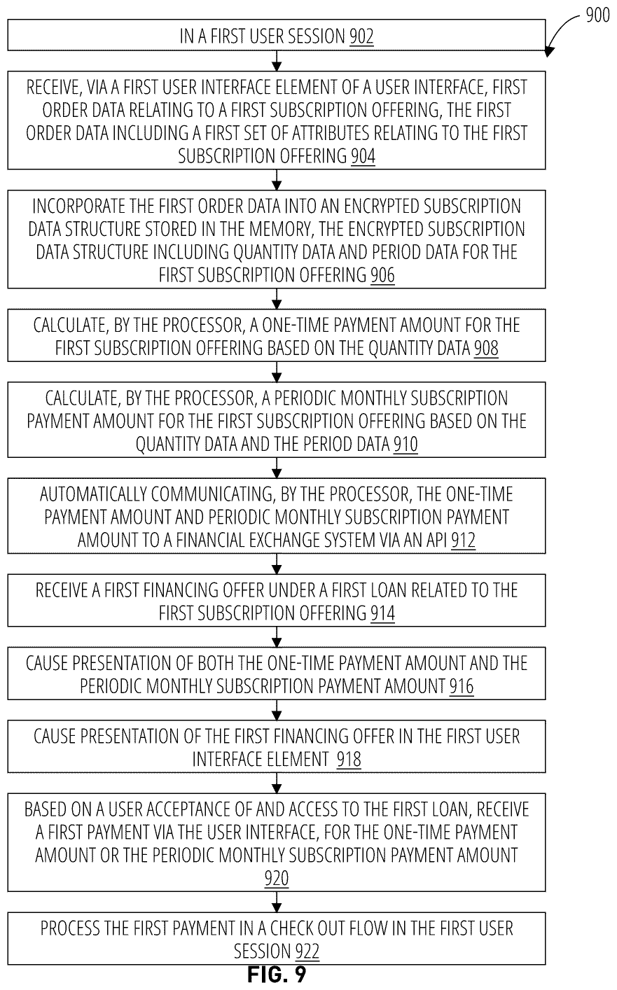

FIG. 9 is a flowchart illustrating a method 900, according to some example embodiments, to create a loan and subscription plan data structure and to facilitate financing of the subscription plan reflected in the data structure. Method 900 elaborates on or supplements some of the operations described just above.

Although the described flow diagram below can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

In some examples, the computer-implemented method 900 is executed on a computing device comprising a processor and memory for managing loans and subscriptions in a multi-tenant environment. In operation 902, method 900 proceeds in a first user session. In operation 904, method 900 receives, via a first user interface element of a user interface, first order data relating to a first subscription offering, the first order data including a first set of attributes relating to the first subscription offering. In operation 906, method 900 incorporates the first order data into an encrypted subscription data structure stored in the memory, the encrypted subscription data structure including quantity data and period data for the first subscription offering. In operation 908, method 900 calculates, by the processor, a one-time payment amount for the first subscription offering based on the quantity data. In operation 910, method 900 calculates, by the processor, a periodic monthly subscription payment amount for the first subscription offering based on the quantity data and the period data. In operation 912, method 900 automatically communicating, by the processor, the one-time payment amount and periodic monthly subscription payment amount to a financial exchange system via an API. In operation 914, method 900 receives a first financing offer under a first loan related to the first subscription offering. In operation 916, method 900 causes presentation of both the one-time payment amount and the periodic monthly subscription payment amount. In operation 918, method 900 causes presentation of the first financing offer in the first user interface element. In operation 920, method 900 based on a user acceptance of and access to the first loan, receives a first payment via the user interface, for the one-time payment amount or the periodic monthly subscription payment amount. In operation 922, method 900 processes the first payment in a check out flow in the first user session.

The computer-implemented method may also include, in a second user session, receiving a second payment via the user interface, determining whether a payment under the first loan is due, or whether the first loan is paid off, based on a determination that a payment under the first loan is due, applying the second payment to the first loan by the processor, or based on a determination that the first loan is paid off, applying the second payment as a credit to a user account by the processor, or as payment for an item or service in a check out flow in the second user session, and processing the second payment by the processor and updating the encrypted subscription data structure.

The computer-implemented method may also include where the credit is applied to a digital wallet associated with the user account.

The computer-implemented method may also include further includes receiving a user request to access the digital wallet in a check out flow during the first or second user session.

The computer-implemented method may also include further includes, in the first user session receiving, via a second user interface element of the user interface, second order data related to a second subscription offering, the second order data including a second set of attributes related to the second subscription offering, incorporating the second order data into the encrypted subscription data structure, the encrypted subscription data structure including quantity data and period data for the second subscription offering, calculating a one-time payment amount and a periodic monthly subscription payment amount for the second subscription offering, automatically communicating the one-time payment amount and periodic monthly subscription payment amount for the second subscription offering to the financial exchange system via the API, receiving a second financing offer under a second loan related to the second subscription offering, causing presentation, in the second user interface element, of the one-time payment amount and the periodic monthly subscription payment amount for the second subscription offering, and causing presentation of the second financing offer in the second user interface element.

The computer-implemented method may also include further includes presenting a toggle feature in the user interface to toggle between presentations of the first and second user interface elements.

The computer-implemented method may also include further includes receiving third order data relating to a third offering, the third offering having a one-time payment option only, the method further includes a presentation of a one-time payment amount related to the third offering.

The computer-implemented method may also include where each of the first and second sets of attributes includes an item identifier associated with at least one of an item or a service.

The computer-implemented method may also include where each of the first and second set of attributes includes a recurring attribute identifying the respective offering as being a recurring offering, and where the first and second order data is incorporated based on the recurring attribute.

The computer-implemented method may also include where the financial exchange system provides financing options relating to the periodic monthly subscription payment amounts to financiers.

The computer-implemented method may also include where the communication of the periodic monthly subscription payment amounts includes communicating further information pertaining to each of the first and second subscription offerings, the further information including identification information for a provider and consumer of the offerings.

The computer-implemented method may also include where the first financing offer and second financing offer comprise financing terms, the method further including communicating the financing offers from the financial exchange system to be presented via the user interface.

The computer-implemented method may also include where the financing offers include a first financing offer pertaining to the first subscription offering and a second financing offer pertaining to the second subscription offering.

The computer-implemented method may also include where predefined business rules are applied to selectively present at least one of the first or second financing offers via the user interface. Other technical features may be readily apparent to one skilled in the art from the following figures, descriptions, and claims.

Some example methods in loan and subscription management systems include presentation of plan options to a user 118, such as a patient. In one embodiment, the presentation may be made via user interfaces on which an expert (e.g., a cosmetic physician) and the patient collaborate. The presentation may accordingly be done via interfaces that are generated and communicated from an appropriate expert system 124, via a web server 122, to a client device 108 being operated by the expert. FIG. 10-FIG. 31 illustrate examples of such user interfaces in three different check out flows.

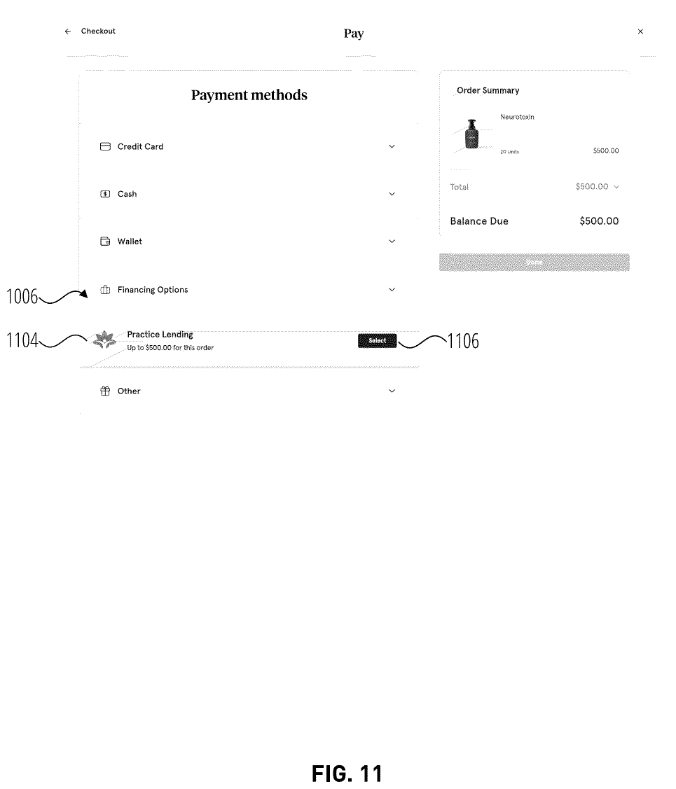

In a first check out flow of FIG. 10-FIG. 16, FIG. 10 shows an example user interface for a medical practice (e.g., tenant 120) to sign up a patient (e.g., user 118) using a client device 108 for a loan and applying the loan as a payment method for a product, service, and/or a subscription. A payment screen 1004 is displayed as an element of a multi-tenant platform user interface flow in which the patient can sign up for a credit line using financing options 1006 to pay the full amount of a given transaction with that newly acquired credit or loan. For this transaction, the patient can see presented at product 1008 an example neurotoxin in the cart and, in a linear check out flow, in FIG. 11, the practice opens up the financing options 1006 and the patient now has access at drop down 1104 to third party lending (loan access).

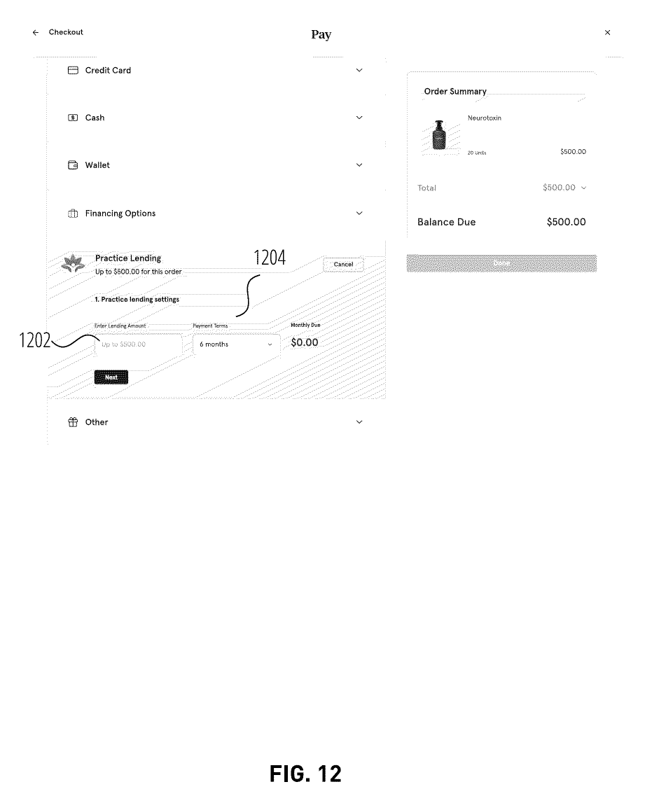

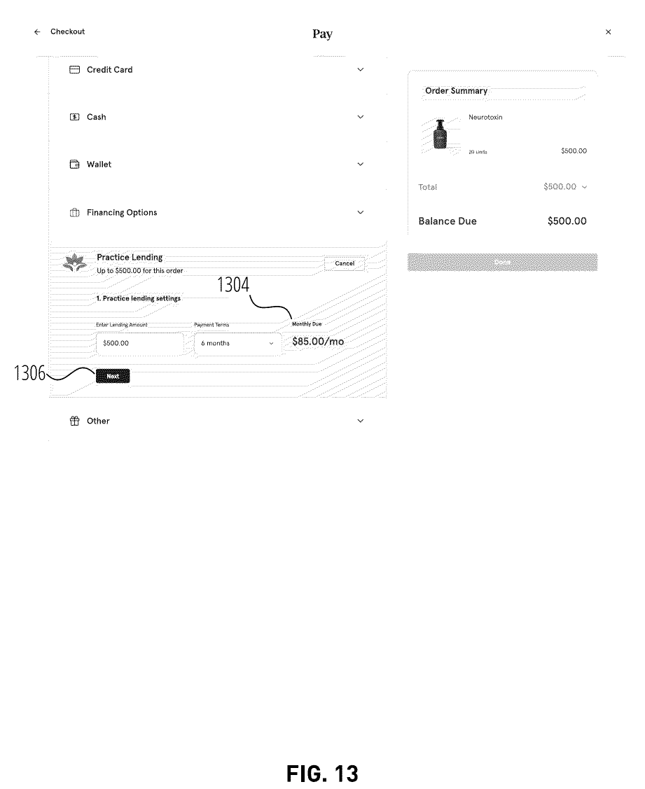

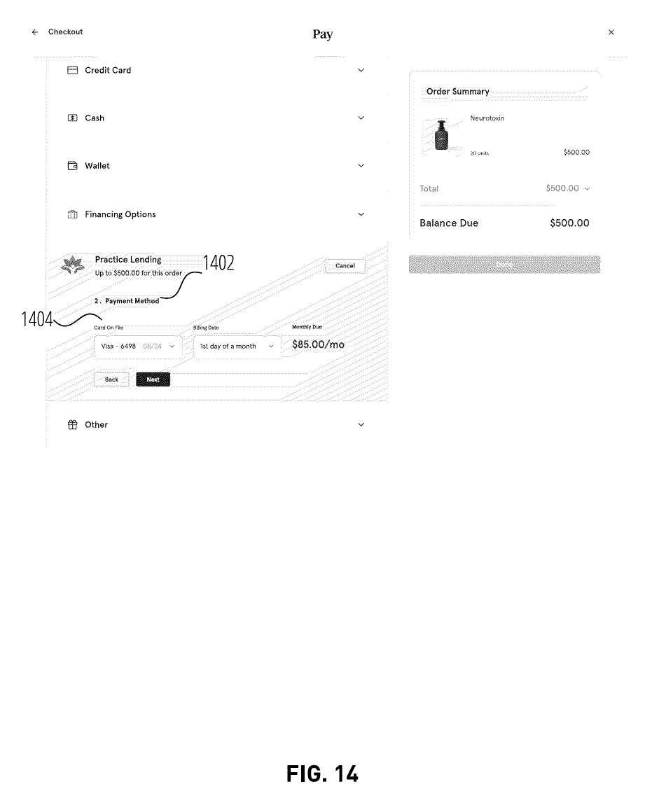

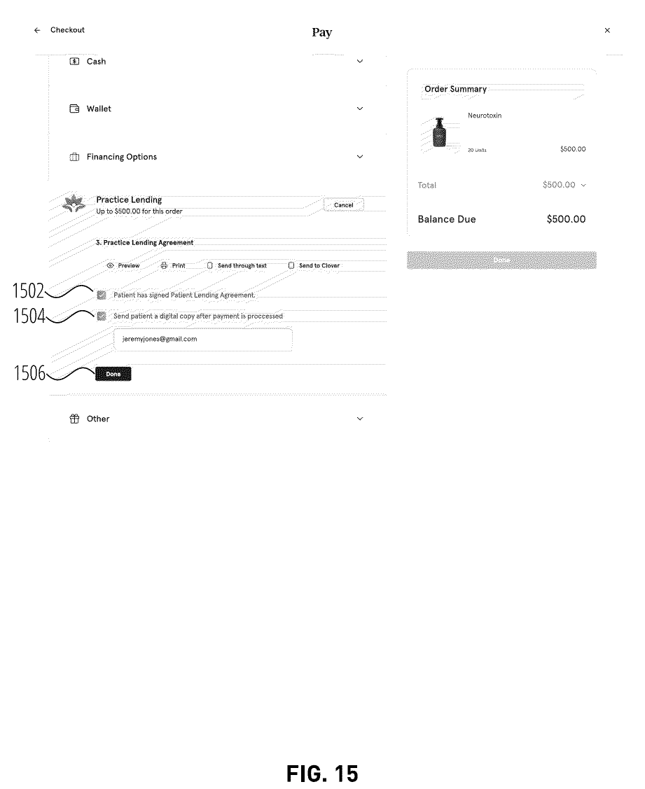

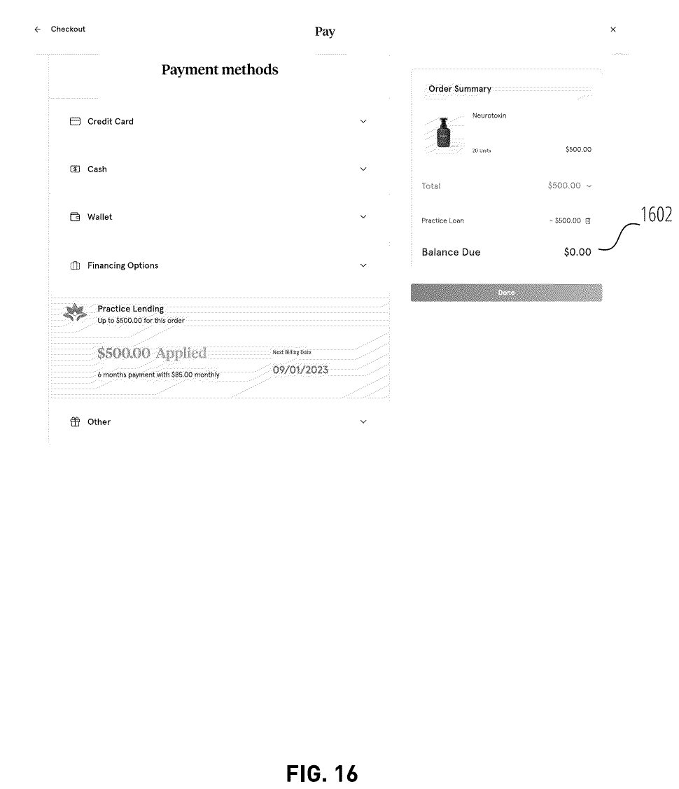

The patient can click the select button 1106 and then, in the FIG. 12 user interface in the linear check out flow, enter a lending amount 1202, for example up to $500, and payment terms 1204 for example defaulted here to six months. In this example, the patient has selected $500 and, in FIG. 13, the accounting module 3336 breaks this amount down to $85 a month. This monthly due 1304 amount is displayed in the user interface accordingly. The patient then selects next button 1306 and is brought in FIG. 14 to a payment method 1402. In this example, a card on file 1404 implemented and placed under the loan selected above is automatically selected and the billing data is selected as well. In the user interface of FIG. 15, the patient checks loan agreement check box 1502 to confirm a signature of an underlying loan agreement, and at digital copy check box 1504, confirms a request for a digital copy thereof. The patient then selects done button 1506 and in FIG. 16 the full amount of the loan is shown applied to the transaction amount to leave a zero balance due 1602.

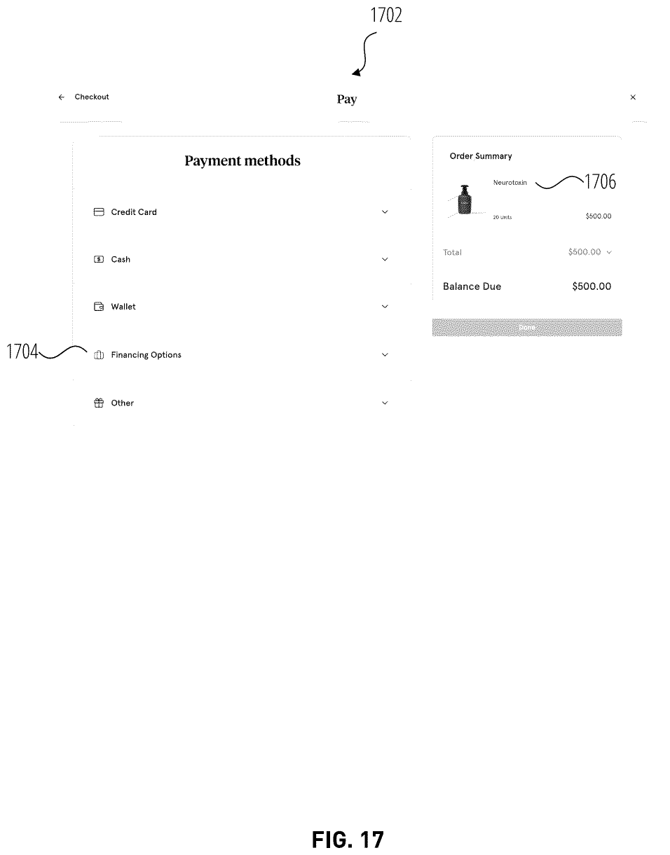

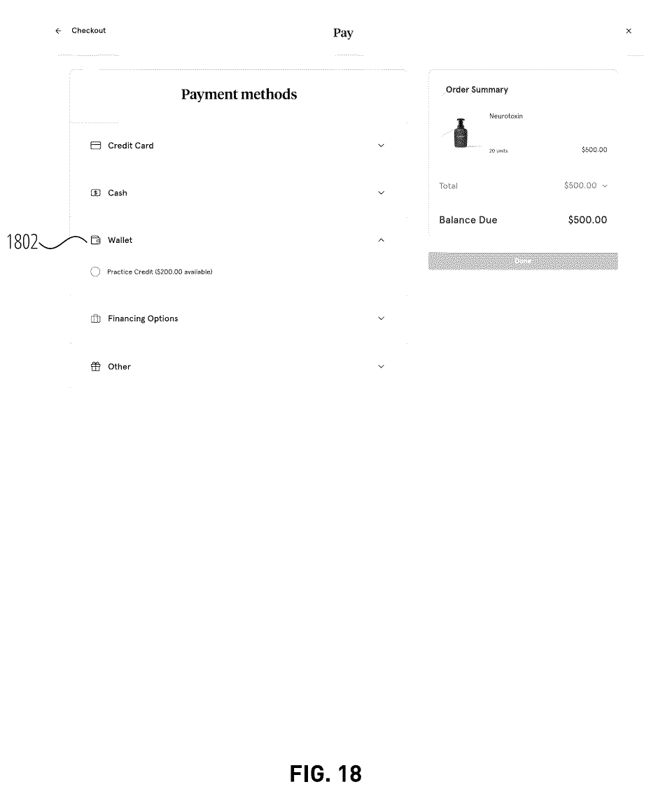

In a second check out flow of FIG. 17-FIG. 24, in the user interface of FIG. 17 a practice credit, for example stored in a wallet, and a loan is used as the payment method. In FIG. 17, example financing options 1704 are again presented in a payment screen 1702 for purchase of a product, service, or subscription, in this case a product 1706. The patient may be new to borrowing (using third party financing options) and is offered the opportunity to sign up for a loan. A loan may be selected and established using the same counterpart user interface elements and in the same manner as described above in the first check out flow. Here, in FIG. 18, the patient is shown as having a practice credit stored for example in a wallet 1802. The practice credit may have antecedently been applied by the practice as a credit based on a prior-received recurring repayment, for example a recurring loan payment for a loan now paid off, as described further above in this disclosure. The recurring payment, originally established as a loan repayment, is applied once the loan is paid off as a credit payment as opposed to payoff of a debt instrument. In this second example check out flow, a practice credit and loan are applied as a hybrid payment in a purchase transaction for the product 1706. The practice credit is now redeemed in a redeem phase for example as shown in FIG. 8.

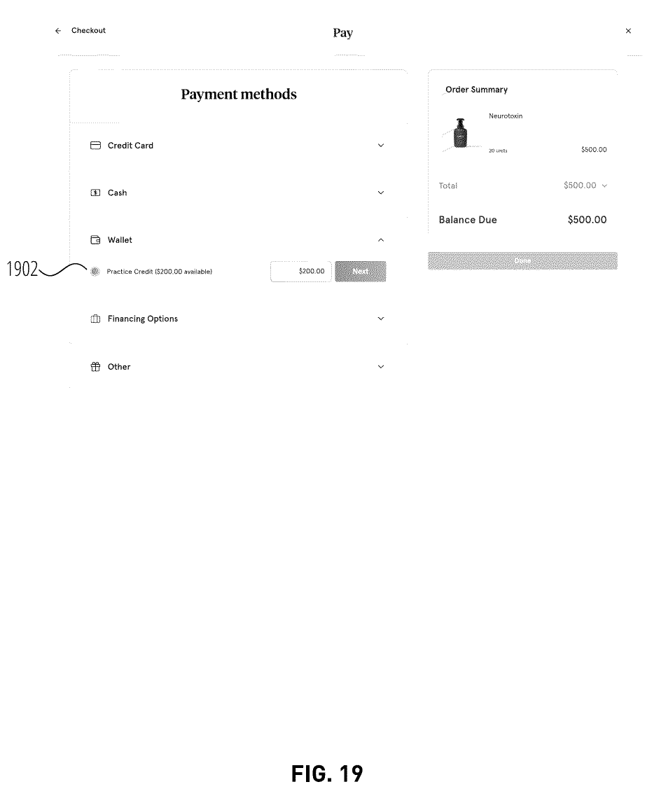

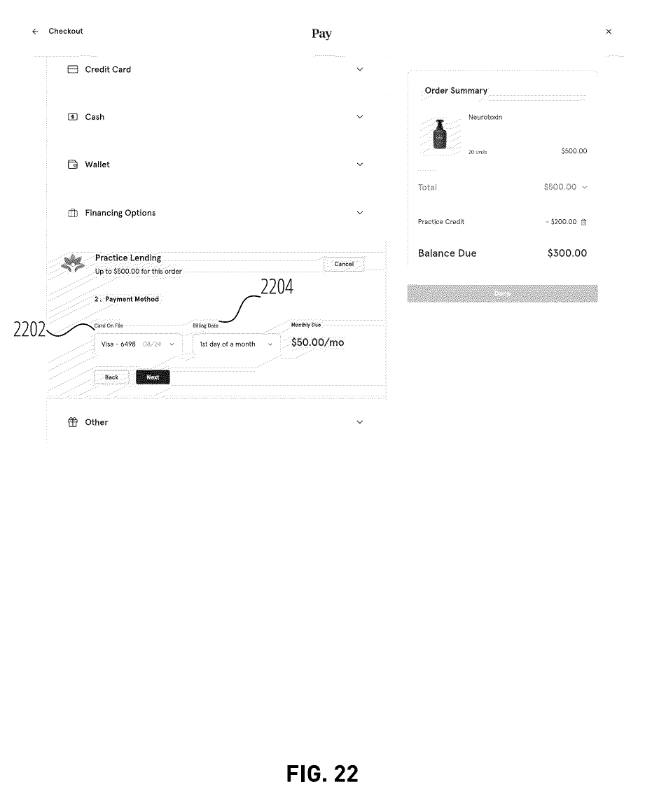

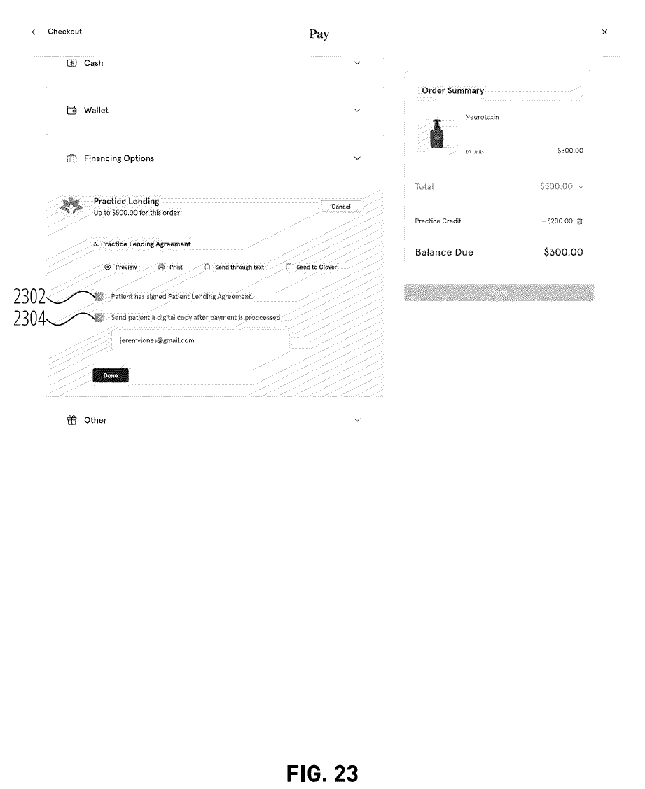

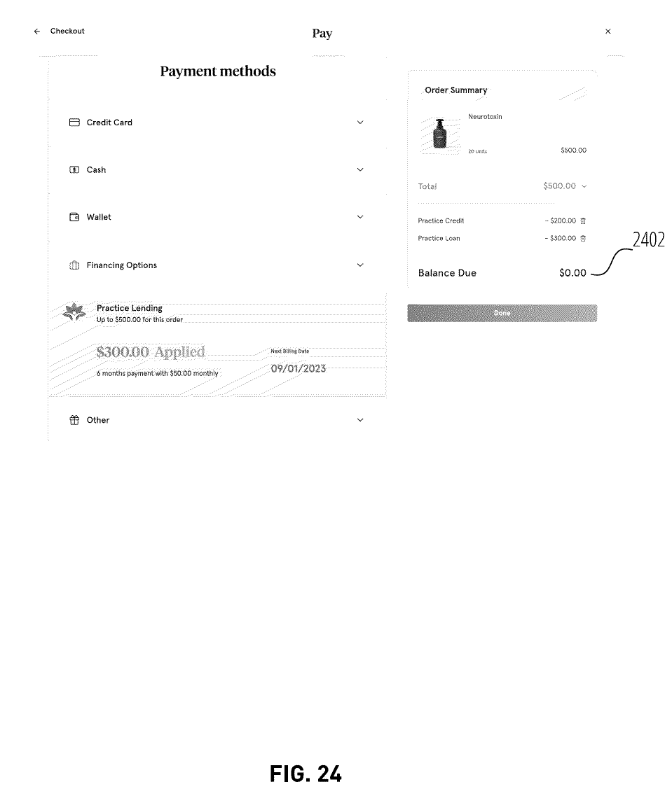

In the user interface of FIG. 19, the user selects application of the practice credit 1902, in this example an interim amount of $200. That $200 credit is applied, for example by the accounting module 3336 described further below, to a cart or order summary 2004. Subsequently, and in a manner as described above in the first check out flow, the patient can additionally select financing options 2102 and enter a loan amount, for example, $300 in the drop down 2104 giving rise to a monthly due 2106 of $50 in this example. In the user interface of FIG. 22, a card on file 2202 is selected, along with a billing date 2204, and in FIG. 23 the patient can check the loan agreement check box 2302 and the digital copy check box 2304 to agree to and apply the loan and its the terms to the practice credit here as well. In the user interface of FIG. 24, both the practice credit 1902 and the practice loan have been applied to leave a zero balance due 2402.

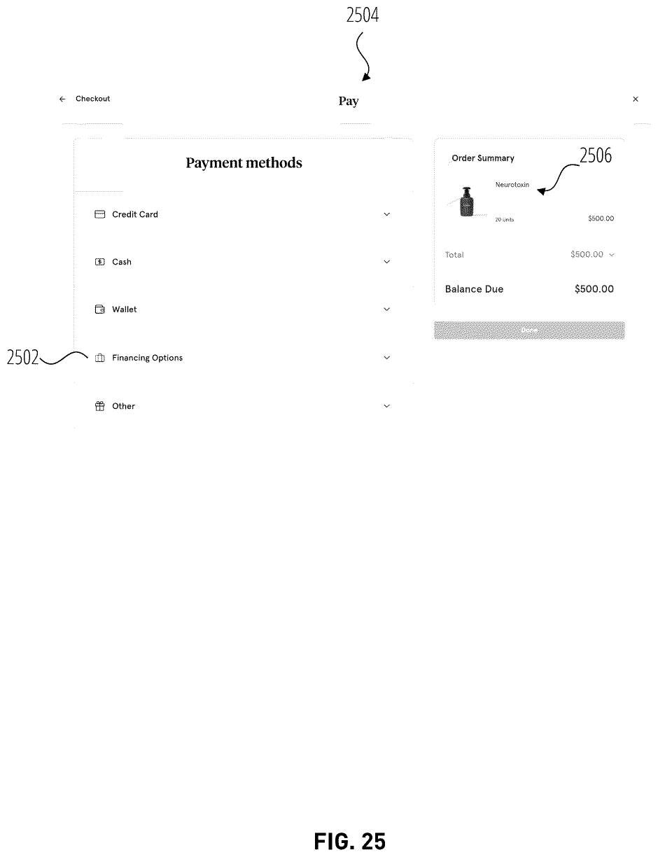

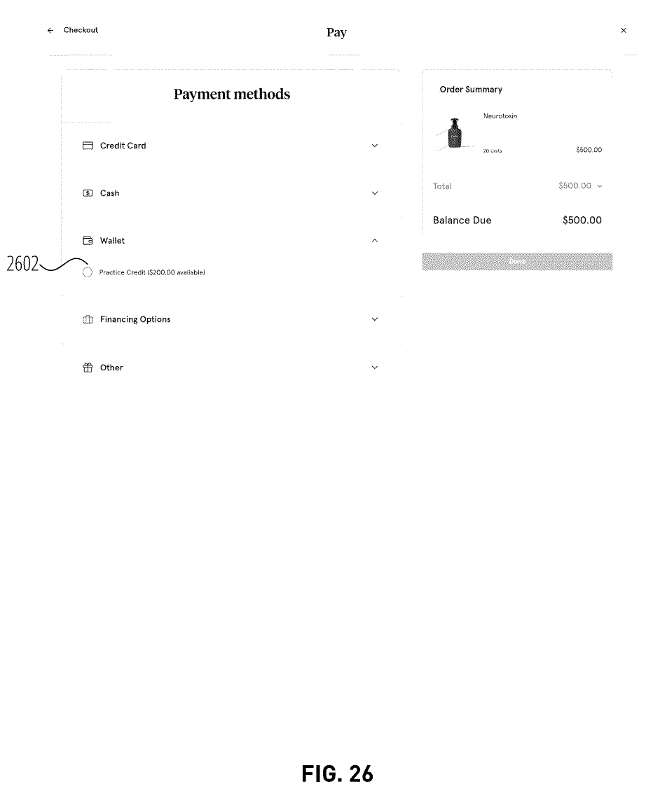

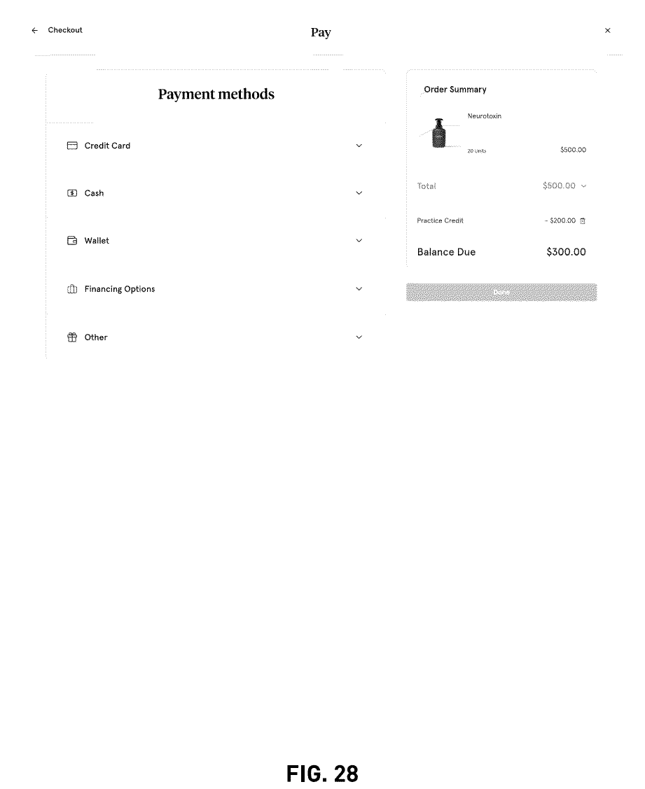

In a third check out flow of FIG. 25-FIG. 31, in the user interface of FIG. 25 example financing options 2502 are again presented in a payment screen 2504 for purchase of a product, service or subscription, in this case a product 2506. In this third check out flow, practice credits and an existing loan (also known as a lending amount) are used as the payment method. The patient has access to a previously set loan or lending amount and can draw from that lending amount any they visit their practice. The previously set loan or lending amount may be stored and presented in a digital wallet, for example as shown in FIG. 26 and FIG. 28. In the third check out scenario, the patient uses an existing practice credit and preset lending amount to pull from to purchase the product 2506. The practice credit and/or lending amount may have antecedently been applied by the practice as one or more credits based on a prior-received recurring repayment, for example a recurring loan payment for a loan now paid off, as described further above in this disclosure. The prior-received recurring payment, originally established as a loan repayment, is applied once the loan is paid off as a credit payment as opposed to payoff of a debt instrument.

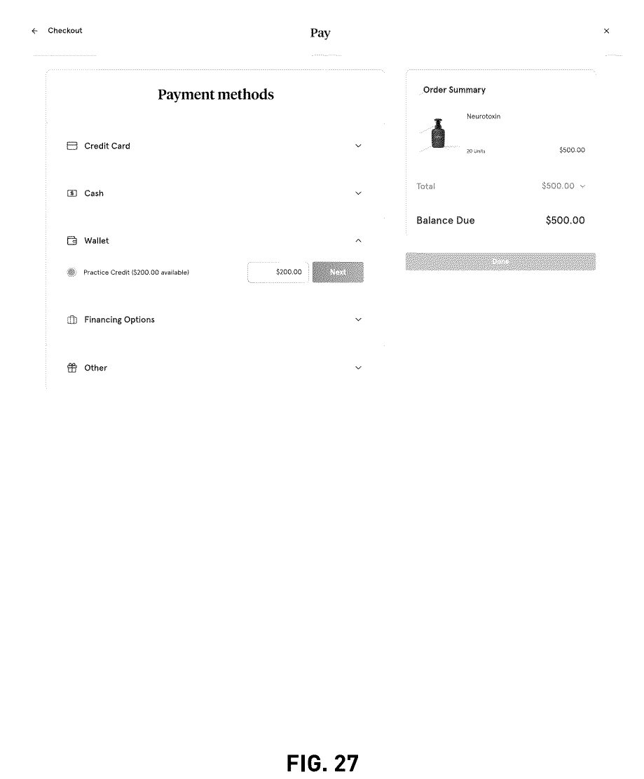

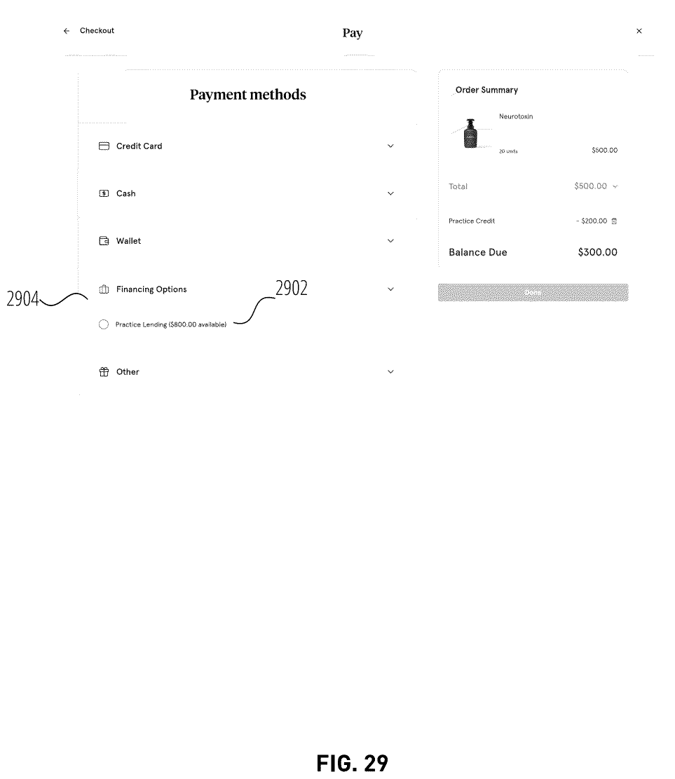

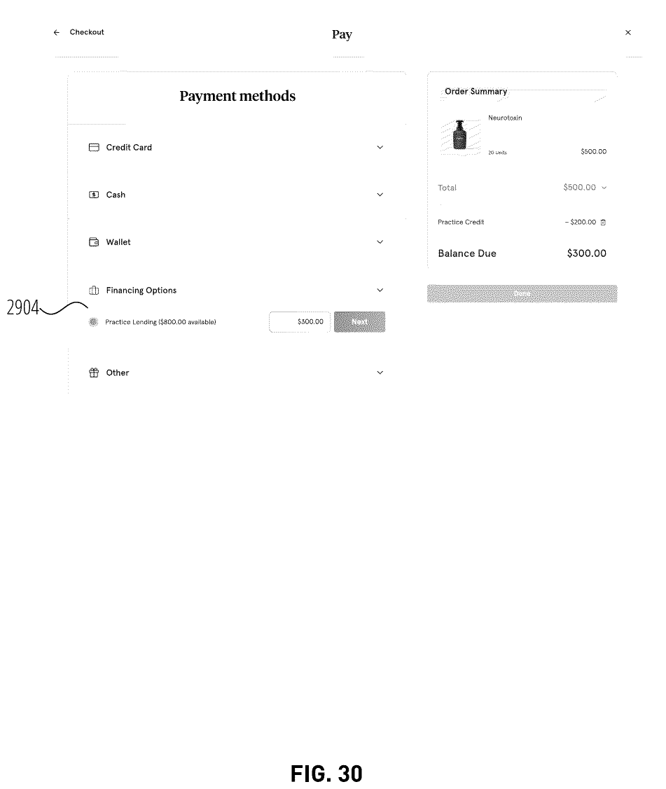

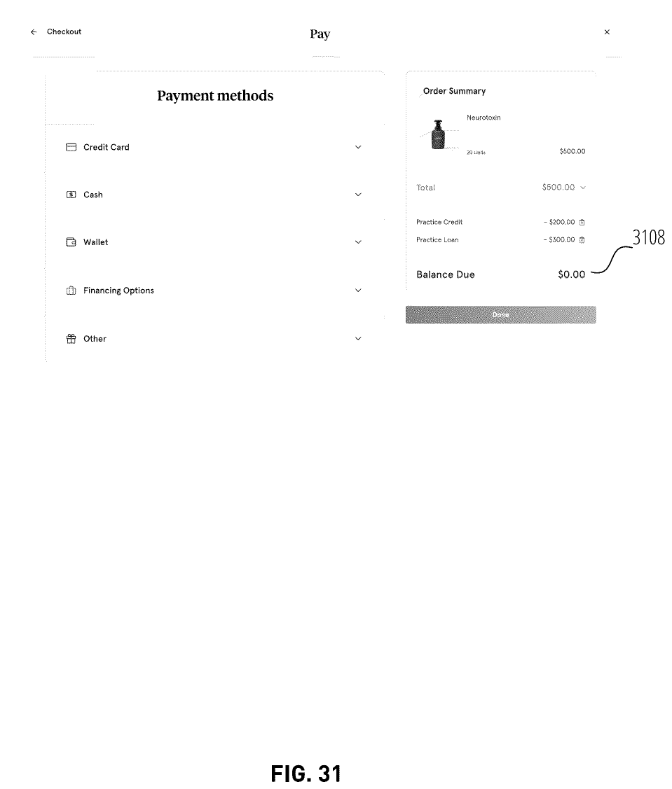

Like the second check out flow, in the user interface of FIG. 27, the patient can open up the wallet to apply the $200 practice credit as shown in FIG. 28. In further financing options, for example as shown in the user interface of FIG. 29, the patient can select a practice lending amount 2902 amount. In the financing options drop down 2904 it is shown that the patient has a lending amount of $800 available to them. In the user interface of FIG. 30, the patient has selected an amount ($300) lower than the full amount ($800) available to borrow. In the user interface of FIG. 31, the practice credit 2602 and the practice lending amount 2902 are both applied to the purchase of the product 2506 to leave a zero balance due 3108.

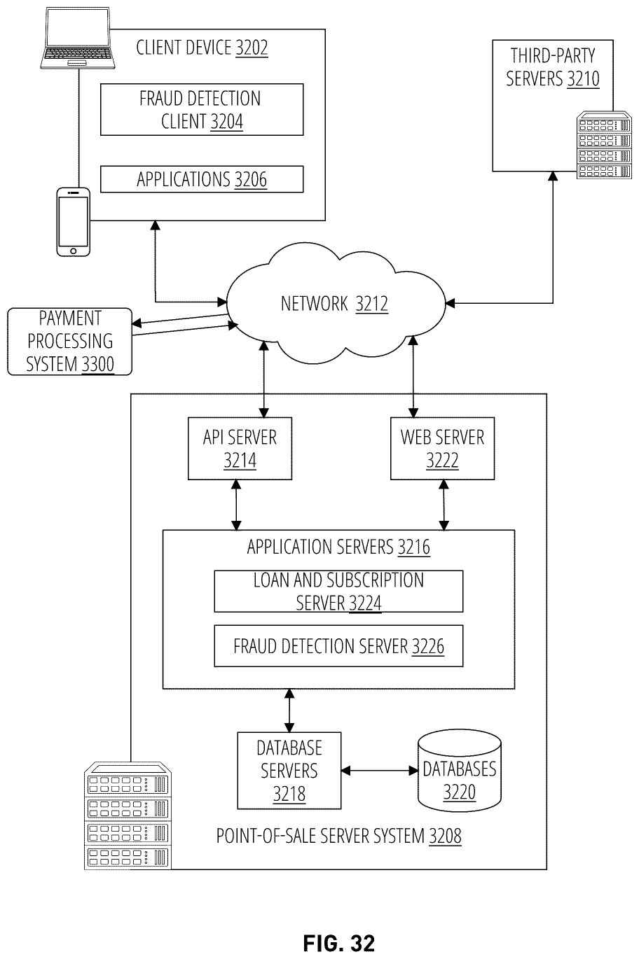

FIG. 32 is a block diagram showing an example point-of-sale system for conducting transactions over a network. The point-of-sale system is communicatively coupled to the payment processing system 3300 as part of the processing of card present payment transactions as described more fully below. The point-of-sale system includes multiple instances of a client device 3202, each of which hosts a number of applications, including a fraud detection client 3204 and other applications 3206. Each fraud detection client 3204 is communicatively coupled to other instances of the fraud detection client 3204 (e.g., hosted on respective other client devices 3202), a point-of-sale server system 3208, and third-party servers 3210 via a network 3212 (e.g., the Internet). The applications 3206 can also communicate with other locally-hosted applications 3206 using Applications Program Interfaces (APIs).

The point-of-sale server system 3208 provides server-side functionality via the network 3212 to a fraud detection client 3204. While certain functions of the point-of-sale system are described herein as being performed by either a fraud detection client 3204 or by the point-of-sale server system 3208, the location of certain functionality either within the fraud detection client 3204 or the point-of-sale server system 3208 may be a design choice. For example, it may be technically preferable to initially deploy certain technology and functionality within the point-of-sale server system 3208 but to later migrate this technology and functionality to the fraud detection client 3204 where a client device 3202 has sufficient processing capacity.

The point-of-sale server system 3208 supports various services and operations that are provided to the fraud detection client 3204. Such operations include transmitting data to, receiving data from, and processing data generated by the fraud detection client 3204. This data may include transaction data, customer data, product data, subscription data and provider data, as examples. Data exchanges within the point-of-sale server system 3208 are invoked and controlled through functions available via user interfaces (UIs) of the fraud detection client 3204.

Turning now specifically to the point-of-sale server system 3208, an API server 3214 is coupled to, and provides a programmatic interface to, application servers 3216. The application servers 3216 are communicatively coupled to a database server 3218, which facilitates access to a database 3220 that stores data associated with the transactions processed by the application servers 3216. Similarly, a web server 3222 is coupled to the application servers 3216 and provides web-based interfaces to the application server 3216. To this end, the web server 3222 processes incoming network requests over the Hypertext Transfer Protocol (HTTP) and several other related protocols.

The API server 3214 receives and transmits transaction data (e.g., commands and transaction data) between the client device 3202 and the application servers 3216. Specifically, the API server 3214 provides a set of interfaces (e.g., routines and protocols) that can be called or queried by the fraud detection client 3204 in order to invoke functionality of the application servers 3216. The API server 3214 exposes various functions supported by the application servers 3216, including account registration, subscription creations and management, the processing of transactions, via the application servers 3216, from a particular fraud detection client 3204 to another fraud detection client 3204.

The application servers 3216 host a number of server applications and subsystems, including, for example, a loan and subscription server 3224 and a fraud detection server 3226. The loan and subscription server 3224 implements functionalities for creating and managing subscriptions between multiple client devices 3202.

The fraud detection server 3226 provides functionalities for pre-declining fraudulent card transactions based on an evaluation of the transaction. Further details regarding the fraud detection server 3226 are provided below.

With reference to FIG. 33, in some examples, the point-of-sale server system 3208 is included in a payment processing system 3300 or conglomerate of payment systems. The payment processing system 3300 may include payment deduplicating and fraud-detecting functionality. The payment processing system 3300 processes payment or transaction data.

As mentioned above, the payment processing system 3300 includes an accounting module 3336 in some examples. The accounting module 3336 handles the accounting treatment and reporting for both loans and subscriptions within the system. The accounting module 3336 integrates with standard accounting software packages through APIs. This allows it to record accounting entries and journal transactions in the appropriate accounts.

The accounting module 3336 is configurable to support different accounting standards and practices. This flexible technical support and capability can be important since accounting treatment may vary between different tenant 120. For loans, the accounting module 3336 records principal balances, interest accruals, payments received, and aging. This allows tracking of loan status over time. For subscriptions, the accounting module 3336 handles revenue recognition rules, deferred revenue tracking, and revenue booking. This properly records subscription revenue.

The accounting module 3336 generates accounting reports and dashboards for financial monitoring. This includes income statements, balance sheets, aging reports, and revenue forecasts. In some examples, the accounting module 3336 handles tax filings and documentation related to loans and subscriptions. This includes tax forms, sales tax calculations, and deductibility. The accounting module 3336 automates accounting compliance related to loans and subscriptions. For example, loan disclosures, subscription terms and conditions, and so forth. The accounting module 3336 generates audit trails, logging, and implements controls to ensure accounting accuracy and prevent fraud. The accounting module 3336 interfaces with third party loan providers to exchange accounting data. Overall, the accounting module 3336 automates the complex accounting treatment and compliance for hybrid loan/subscription models in an accurate, configurable, and auditable way.

In relation to fraud detection operations, the payment processing system 3300 may operate as or include a microservices depot including connections to one or more microservices databases, for example, including the illustrated microservice databases 3302, 3304, 3306, and 3308. The payment processing system 3300 and microservice databases may operate in a multi-tenant network 3310 including at least one tenant 120, as an example tenant (e.g., tenant 120 of FIG. 1) in the multi-tenant network 3310. The tenant 120 may serve a consumer or patient (for example the user 118 of FIG. 1) and seek to receive a payment from this party for a subscription, item, or service, for example.

In some examples, the payment processing system 3300 includes a number of microsystems that each provide an associated microservice for a given tenant in the multitenant environment. Example microservices may include a point-to-point (P2P) encryption microservice (that writes to the microservice database 3302, for example), a global gateway microservice (that writes to the microservice database 3304, for example), a card microservice (that writes to the microservice database 3306, for example), and a payment microservice (that writes to the microservice database 3308, for example). Other microservices are possible.

In an example transaction, a patient at the tenant 120 swipes a card to pay for a product or service. Many other different types of transactions 3312 (such as sales (purchase), refunds, credits, loyalty program redemptions and so forth) may be received from any one or more of the patients at any one of more of the tenants in the multi-tenant network 3310. The numbers of patients and tenants can run into the thousands or even millions. It will be appreciated that the number, variety, and complexity of the transactions 3312 can be extremely high. In some examples, the payment processing system 3300 is configured to process this great multiplicity of transactions to check for fraud in near real-time.

When the example transaction is received at the tenant 120, at least one of the microservices in the payment processing system 3300 is invoked based on the nature or type of the transaction and writes out to its associated microservice database. As the transactions 3312 each proceed, each microservice database 3302-3308 collects its own related part of the transaction information; for example, the microservice database 3308 collects information for payment transactions (e.g., cash transactions), while the microservice database 3306 collects information for credit or debit card transactions. Other microservices are possible.

In some examples, the microservices depot includes a further microservice (not shown) called a ledger microservice. An associated ledger microservice database stores aspects related to transactional bookkeeping, recording aspects such as a transaction ID, a transaction dollar amount, details of an item, product or service purchased, and so forth. The ledger microservice operates as a ledger and keeps a tally of such details. The ledger information may be distributed or shared with all the other microservices.

In some examples, the data stored in microservice database 3302-3308 is transmitted (or otherwise made available) at operation 3314 to an “extract, load and transform” (ELT) tool, such as the illustrated ELT tool 3316. An example ELT tool 3316 may be (or include) a Matillion™ ELT tool 3316. For all of the microservices (including the ledger microservice), the ELT tool 3316 can perform ELT operations based on the continuous data supplied to it from the microservices databases 3302, 3304, 3306, and 3308, including, in some examples, the ledger microservice database.

In some examples, an output 3318 of the ELT tool 3316 includes normalized data or online transaction processing (OLTP) data that has been extracted, loaded, and transformed into star schemas and stored in a database, such as the Redshift database 3320. In some examples, the ELT tool 3316 extracts OLTP data, data from external online transaction processing databases, and data from any one or all of the microservice databases; loads the data; transforms this data into an abstracted, online analytical processing structure; and stores this as one or more star schemas in the Redshift database 3320.

In some examples, in parallel with the ELT process, the ELT tool 3316 also aggregates transactional information as part of its transformation, and then pushes at operation 3322 this aggregated data for storage in a Dynamo database 3324. In one sense, this operation may be considered to be moving information from what is a reporting infrastructure into a transaction processing resource. At operation 3326, the payment processing system 3300 and each of the microservices have access to this Dynamo database 3324 for fraud detection purposes and evaluation against near real-time aggregated information and ongoing real-time transactions 3312.

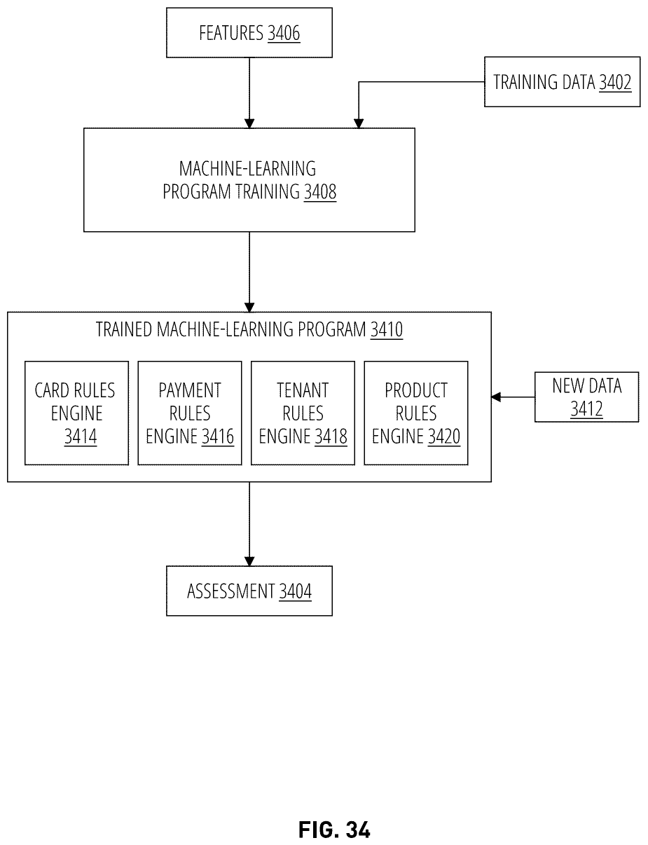

This aggregation of transactional data allows for the creation of fraud detection rules or threshold fraud parameters. Rules or threshold parameters may be based, for example, on an average monthly volume per practice for an individual practice (tenant) or patient. Other rules and thresholds are described further below in connection with machine learning with reference to FIG. 34.

As opposed merely to providing fixed fraud detection rules or threshold parameters, some examples allow for dynamic rule setting and flexibility in configuration. Assume a new practice joins a medical network as an example multitenant environment. Here, based on the type of practice it is and based on what has been seen historically across sets of practices, examples allow different machine learning algorithms to predict what an average sales price for use as a fraud detection trigger might be for the new practice. The new practice can be immediately protected and “inherit” existing rules and threshold parameters, accordingly.

Examples can also predict that a purchase, for example a neurotoxin like Botox, includes a certain average reorder time or purchase frequency. A purported reorder transaction for the same product that is received in too short a time, or at an increased frequency, is potentially fraudulent. Based on such purchase patterns, fraud scores for a given transaction can be developed and processed, accordingly. This is described in greater detail below with reference to FIG. 34.

In relation to payment deduplication functionality, some examples of a payment processing system 3300 herein generate an alert based on a detection that multiple payments are being issued for the same purchase of a subscription, item, or service in order to prevent multiple payments being collected for the same purchase. Examples seek to provide a technical solution assisting users to prevent re-running multiple payments for the same purchase, either inadvertently or due to system glitches.

In this regard, the payment processing system 3300 includes at least one processor and a memory storing instructions that, when executed by the at least processor, cause the payment processing system 3300 to perform operations comprising detecting a card-present (CP) transaction request that comprises a set of CP transaction data, the CP transaction request relating to a purchase of an item or service and initiated by a card swipe or card tap made by human user (for example, user 118) at a Point-of-Sale tenant device 110 device operating at a tenant (for example a tenant 120) in a multi-tenant network (for example multi-tenant network 3310); accessing the CP transaction data; monitoring a flow of the CP transaction data across a plurality of communicatively-coupled CP transaction processing components, the CP transaction processing components including at least the tenant device 110, a federation layer 3330 executing between tenants 120 in the multi-tenant network 3310, a peer-to-peer encryption service 3332 accessible by the tenant device 110 and invoked by the CP transaction request, a gateway service 3334 acting as an exclusive contact point for the tenant device 110, and an application-support server (for example, application server 104) executing or processing data for a payment application to present at least some of the CP transaction data in a user interface of a mobile device (for example, client device 108) operated by the human user; detecting a failure or breakdown in the flow of monitored CP transaction data; detecting an attempted re-initiation of the CP transaction request for the same purchase of the item or service, the attempted re-initiation of the CP transaction request made after the detected failure or breakdown in the flow of monitored CP transaction data, the re-initiated CP transaction request including re-initiated CP transaction data; accessing the re-initiated CP transaction data; based on the detected re-initiation of the CP transaction request, comparing the CP transaction data against the re-initiated CP transaction data to identify an attempted duplicated payment for the purchase of the item or service; and based on the identified attempted duplicated payment, initiating a payment deduplication phase by generating a potential payment duplication alert for presentation at the tenant device 110 and/or in the user interface of the client device 108 operated by the human user.

In some examples, the operations further comprise, based on a response to the payment duplication alert, progressing the payment deduplication phase by voiding, or facilitating a voiding of, either one of the initial and re-initiated CP transaction requests. In some examples, progressing the payment deduplication phase further comprises processing a non-voided initial or re-initiated CP transaction request. In some examples, the response to the potential payment deduplication alert is received at the tenant device 110. In some examples, the response to the potential payment deduplication alert is received from the mobile device (client device 108) operated by the human user.

In some examples, comparing the CP transaction data against the re-initiated CP transaction data further comprises inputting the CP transaction data into a machine-learned model trained to analyze a set of historical transaction data, the set of historical transaction data having been aggregated from one or more historical data sources, the one or more historical data sources including at least one microservice database collecting a particular aspect of transactional data processed by a corresponding microservice of the tenant in the multi-tenant network; using an output of the machine-learned model to generate a transaction comparison fingerprint based on common or repeated tenant or human user payment transactions; storing the transaction comparison fingerprint in a transaction comparison fingerprint cache table, and monitoring a frequency or number of times the CP transaction data matches a transaction comparison fingerprint; comparing the CP transaction data against at least one transaction comparison fingerprint in the transaction comparison fingerprint cache table to generate a comparison result; and based on the comparison result, or the monitored frequency or number of matches, generating the potential payment duplication alert.

In some examples, monitoring the flow of the CP transaction data across the plurality of communicatively-coupled CP transaction process components includes monitoring for a failure or breakdown including at least one of a card decline, a network error, a request time out, a gateway time out, a failed response receipt, a bank error, a processor error, a lost connection, a power loss, a device reboot, and a device restart. In some examples, the tenant in the multi-tenant network is an aesthetic medical practice in a network of medical service providers, and wherein the human user is a patient at the aesthetic medical practice.

FIG. 34 illustrates the training and use of a machine-learning program, according to some embodiments that may be used in conjunction with the fraud detection and payment deduplication (e.g., fingerprint generation) operations discussed above in connection with FIG. 33. In some embodiments, machine-learning programs (MLPs), also referred to as machine-learning algorithms or tools, are utilized to perform operations associated with malware classification. Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 3402 in order to make data-driven predictions or decisions expressed as outputs or assessment 3404. Although some embodiments are presented with respect to a few machine-learning tools, the principles presented herein may be applied to other machine-learning tools.

In some embodiments, different machine learning tools may be used. For example, Logistic Regression (LR), Naive-Bayes, Random Forest (RF), neural networks (NN), matrix factorization, and Support Vector Machines (SVM) tools may be used for classifying or scoring transaction data.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, example machine-learning algorithms provide a prediction probability to classify an image as digitally manipulated or not. The machine-learning algorithms utilize the training data 3402 to find correlations among identified features 3406 that affect the outcome.

The machine-learning algorithms utilize features 3406 for analyzing the data to generate an assessment 3404. The features 3406 are an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs. In one embodiment, the features 3406 may be of different types. For example, the features 3406 may be features of historical transaction data.

The machine-learning algorithms utilize the training data 3402 to find correlations among the identified features 3406 that affect the outcome or assessment 3404. In some embodiments, the training data 3402 includes labeled data, which is known data for one or more identified features 3406 and one or more outcomes, such as detecting fraudulent transactions.

With the training data 3402 and the identified features 3406, the machine learning tool is trained during machine-learning program training 3408. Specifically, during machine-learning program training 3408, the machine-learning tool appraises the value of the features 3406 as they correlate to the training data 3402. The result of the training is the trained machine-learning program 3410.

When the trained machine-learning program 3410 is used to perform an assessment, new data 3412 is provided as an input to the trained machine-learning program 3410, and the trained machine-learning program 3410 generates the assessment 3404 as output. For example, when transaction data is received, the historical transaction data is accessed, and the weights of the corresponding data sources are computed, the machine-learning program utilizes features of the historical transaction data to determine if the received transaction request is fraudulent or not.

In some examples, the trained machine-learning program 3410 includes a series of rules engines. Each rules engine includes a list of rules that the incoming transaction request is evaluated against before providing the assessment 3404. For example, the trained machine-learning program 3410 may include a card rules engine 3414, a payment rules engine 3416, a tenant rules engine 3418, and a product rules engine 3420. The card rules engine 3414 includes a set of rules that the card data associated with transaction request must be evaluated against before providing the assessment 3404. The payment rules engine 3416 includes a set of rules that the payment data associated with the transaction request must be evaluated against before providing the assessment 3404. The tenant rules engine 3418 includes a set of rules that the customer data associated with the transaction must be evaluated against before providing the assessment 3404. The product rules engine 3420 includes a set of rules that the product data must be evaluated against before providing the assessment 3404.

In some examples, payment transaction data or a fingerprint may be based on or include one or more of a merchant (tenant) ID, a patient (user) ID, or an amount of time, for example a payment transaction including these three value fields performed within a value X of a monitored time period or frequency, where X is a configurable value.

In some examples, training data for machine learning purposes is aggregated and encrypted (or anonymized) in a multitenant environment. Some fraud detection examples relate to or include data aggregation and anonymization in multi-tenant networks or networks and, in some examples, to a data aggregator and anonymizer that can encrypt sensitive data received from multiple tenants as data sources. The sensitive data may include Personally Identifiable Information (PII), Protected Health Information (PHI) and Payment Card Industry (PCI) information. In some examples, anonymized data can be aggregated for multi-faceted testing without disclosing sensitive aspects. In some examples, the aggregated data can be selectively unencrypted to a given tenant.

Results derived from an analysis of “big data” can generally be improved if the volume of test data is significant. Typically, the larger the volume of test data, the more accurate an analysis of it will be. For example, there is greater chance to identify data outliers and trends in a significant body of data. Data aggregation, however, is not easy. It may be aggregated from different sources, but each source will likely have different methods of data protection with which to comply. Each source will also very often have different data content and configuration, and this may conflict with data configuration of other sources. This aggregation of disparate sources of protected information presents technical challenges, particularly in multi-tenant networks or environments. The more data that is collected, the more complicated the security protocols become and the greater the risk of inadvertent disclosure or malicious access to it. Great care is required not to disclose encrypted information to third-party sources of aggregated data, or third-party “big data” analyzers scrutinizing collected data for discernible trends or machine-learning purposes, for example.

According to some example embodiments, techniques and systems are provided for data aggregation and anonymization in multi-tenant networks or environments. In some examples, a data aggregator and anonymizer platform can encrypt sensitive data received from multiple tenants as data sources. The sensitive data may include PII, PHI, and PCI information. In some examples, anonymized data can be aggregated for multi-faceted testing without disclosing sensitive aspects. In some examples, a portion of the aggregated data can be selectively unencrypted and returned or presented to a tenant that was the original source or keeper of that portion of the aggregated data. The remainder of the portions are not unencrypted and may continue to form part of a body of test data.

Fundamental problems that may arise when processing data in strict compliance to a regulated environment, involving PPI, PHI, or PCI for example, can occur at a confluence of healthcare and treatment information records. One challenge includes simulating a set of problems in production data using test data. For a single medical practice, for example, subscribing along with other medical practices (tenants) to a loan and subscription service (for example) in a multi-tenant network, using a small set of test data based on its own production data may limit the body of test data that can be assembled. On the other hand, trying to build a bigger set of test data by incorporating data from other tenants accessible in the multi-tenant network runs a serious risk of privacy invasion and breach of compliance laws. Further, a desire to collect a large body of data for testing and analysis may include sourcing data that is external to the multi-tenant network and may involve the participation of third parties to analyze the data (e.g., “big data” analysis). Thus, data protection laws prevent a mere aggregation of production data for test purposes.

In other aspects, a further challenge is to simulate realistically, in test environments, what is really happening in production environments. It is difficult to obtain a representative sample of test data that actually and realistically reflects production conditions of whatever aspect the tenant may be developing (for example, an updated health service to patients, a new product offering, or an enhanced online functionality).

In further challenging aspects, production and test systems usually have layers. Lower layers can be accessed by many people, while higher layers can be accessed by relatively few. Access and security protocols differ across layers. In a regulated environment, one cannot easily bring down test information into lower layers because this may violate one or more compliance laws since wider access to this information is provided.

In order to address these and other challenges, some present examples, at a high level, classify and encrypt test information, in particular sensitive information contained in the test information before it is brought down to lower layers. A representative sample of anonymized test data is made available for testing and, in some examples, is configurable based on data fields that might remain or are encrypted, among other factors. Once the encrypted information is brought down to lower layers, the anonymized test data may be used for a variety of testing purposes during development of a service or product, as discussed above.

Some present examples aggregate data to create a body of test data. The aggregated data may include data sourced from sources other than a single tenant (in other words, an aggregation of multi-tenant or multi-party data). For testing purposes, data analysis, or machine training purposes, an enhanced body of test data may be useful to a tenant or third-party data analyzer even though not all of the aggregated data may have been sourced from it. In this situation, a complicated cross-matrix of protection protocols such a PII, PHI, and PCI may apply, and each tenant may be entitled only to view the portion of the data that it supplied (or at least view an unencrypted version of that data). Present examples of a data aggregator and anonymizer platform facilitate the creation and access to such combined test data, yet still allow and greatly facilitate compliance with data protection laws in doing so.

In cloud-based and other modern systems (e.g., Software-as-a-Service (SaaS) platforms and so forth), most enterprises rely very heavily on third-party applications to process data. Some of these applications may include “big data” processing systems. The enterprise cannot physically control what these third parties do with their data. While inter-party agreements restricting data access and publication may be established, there is always a possibility of a rogue actor acting outside the agreed terms. A rogue actor at one tenant in a multi-tenant network might use network credentials to access another tenant to look up prohibited data. The accessed data might be used for exploitation or ransomware purposes, for example.

Thus, in some present examples, a data aggregator and anonymizer can aggregate and provide anonymized data that, even if accessed by a rogue actor, does not contain any identifying information. In some examples, a data encryption key is used to encrypt test data. In some examples, a decryption key to unlock test data is destroyed. In some examples, a decryption key to unlock a portion of aggregated test data is provided only to the tenant supplying that portion. The decryption key disallows decryption of any other data. The tenant as a source of data is thus placed in the same (unencrypted) position it was before supplying a portion of data to be aggregated, yet has enjoyed the benefit of results and analysis derived from a much larger body of test data sourced from many other, if not all, tenants in a multi-tenant network. The tenants are reassured that any contributed data that has been aggregated and shared with another tenant or third-party data analyzer has nevertheless remained encrypted for purposes such as testing, “big data” analysis, machine learning, and so forth.

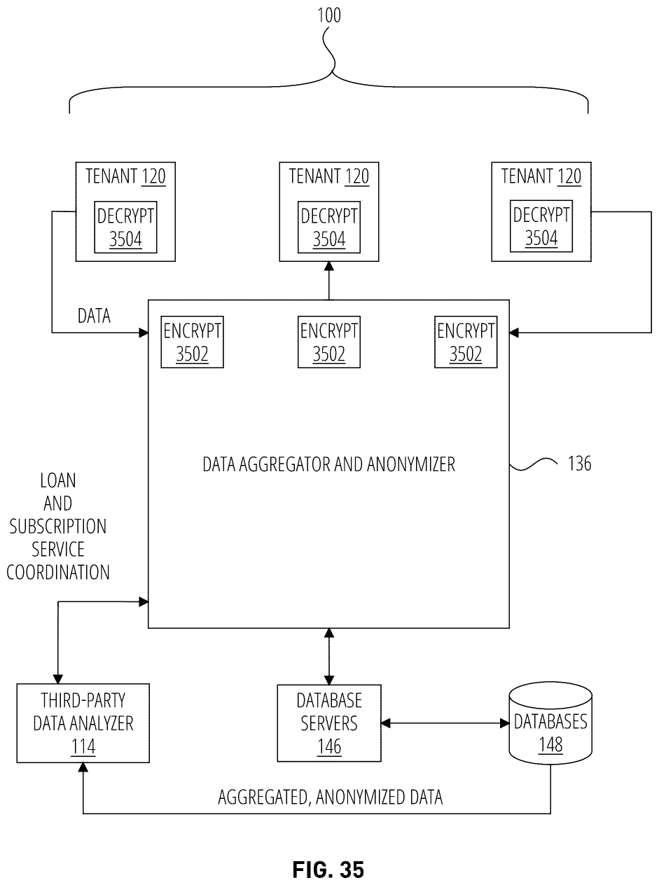

With reference to FIG. 35, in some examples, a tenant 120 in a multi-tenant network 100 may wish to create a testing environment in which to develop a new product or service. To that end, in present examples, the tenant 120 can contact the loan and subscription service 106 and request an aggregation of test data or an analysis of a body of data to help in developing the product or service. The loan and subscription service 106 invokes the data aggregator and anonymizer 136 shown in the view. The tenant 120 may contribute some data, such as production data, to be aggregated or anonymized for test purposes. Some of this production data may be covered by PII, PHI, or PCI requirements and will therefore require appropriate treatment before it can be analyzed by or shared with others. As described more fully below, the aggregated test data is classified to identify sensitive data and encrypted accordingly. The test data is aggregated by the data aggregator and anonymizer 136 to assist in simulating production conditions in which to test the tenant's proposed product or service. In some examples, a plurality of tenants 120 may request an analysis of their respective production data or a simulation of a real-life real-time production environment.

The data aggregated by the data aggregator and anonymizer 136 may be derived from a number of different data sources to assist in creating a realistic test environment or a rich body of data for analysis and training, for example. In some examples, the data may be sourced from a number of sources, without limitation. A data source may include, for example, a single tenant in a network, a plurality of tenants in a network, a single third party outside of a network, or a plurality of third parties outside of a network. Tenants or third parties may be sources of application data, web-based traffic data, or other types of data. Tenants and third parties may offer analysis tools and machine learning models, or other services.

Whether requested by a single tenant 120, or several tenants 120, the aggregated data may comprise a complicated cross-matrix of protection protocols such as PII, PHI, and PCI. Each tenant 120 may be entitled only to view a portion of the data that it supplied or, if permitted, an unencrypted version of that data.

In some examples, data sent by a tenant or accessed by the data aggregator and anonymizer 136 is encrypted at 3502 upon receipt or a grant of access. In some examples, when test data, or analyzed data results, are sent back to a tenant 120, this portion of the data is decrypted at 3504. These processes are described more fully below. The aggregated and anonymized data is stored in a database, such as the one or more databases 148 described above. Present examples of a data aggregator and anonymizer 136 facilitate the creation and access to combined test data, yet still allow and greatly facilitate compliance with data protection laws in so doing.

In some examples, one or more third-party data analyzers 114 may request access to the aggregated and anonymized data stored in the database 148 for purposes of analyzing it to support the tenant's product or service development mentioned above. A third-party data analyzer 114 may be contracted by the loan and subscription service 106, or a tenant 120, to perform data analysis. With appropriate authorization, the third-party data analyzer 114 may be granted access to the data stored in the database 148. To the extent any access is granted, or to the extent a rogue actor may be at work, the aggregated data stored in the database 148 remains anonymized and yields no sensitive information. The data stored in the database 148 may be safely used by the third-party data analyzer 114, or a tenant 120, or the data aggregator and anonymizer 136, in a number of ways including, for example, data analysis, the development of models for machine learning, and for other purposes.

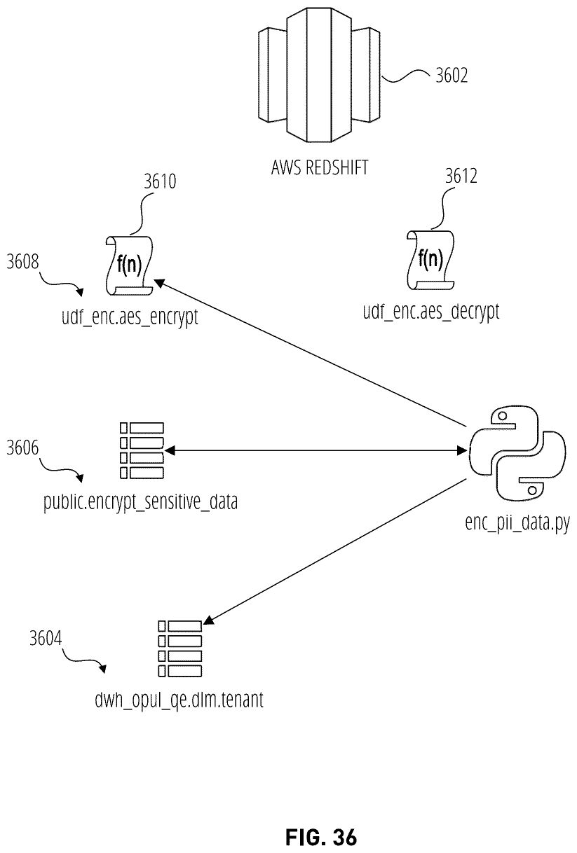

With reference to FIG. 36, some examples, particularly those that utilize the cloud or cloud-based services, include layers, such as software, application, or storage layers, responsible for or utilized in certain aspects of data usage and processing from an origin to post-production. One aspect includes encryption. An example encryption can include an Advanced Encryption Standard (AES). AES follows a symmetric encryption algorithm, i.e., the same key is used to encrypt and decrypt the data. AES supports block lengths of 528, 592, and 556 bits. One example, in a data analytics or reporting tier, includes Amazon Web Services (AWS) Redshift 3602 for encryption and decryption. Redshift is used in some examples to encrypt and decrypt data in various layers. Other encryption software is possible.

In some examples, an AES encryption level is specific to a database persistence layer, for example as shown in FIG. 36. At a first layer 3604, stored data is sourced from one or more tenants 120 and aggregated. At layer 3606, sensitive data in the aggregated data is identified and encrypted. These operations may occur at the data aggregator and anonymizer 136 using database 148 (FIG. 1), for example. Sensitive data is scrambled, hashed, or randomly keyed in some examples. At layer 3608 (for example a lower, widely distributed layer), data is encrypted at 3610 so that it is rendered anonymous. Users operating in this lower level layer 3608 have no access to sensitive data, or if access is obtained, the data is meaningless because it has been anonymized. The data can be decrypted at 3612 as needed for authorized provision to a tenant seeking full access to their data. These encrypt/decrypt operations may occur at the data aggregator and anonymizer 136 or at a tenant 120 (FIG. 1), in some examples. The aggregated, anonymized data may be stored in database 148 (FIG. 1).

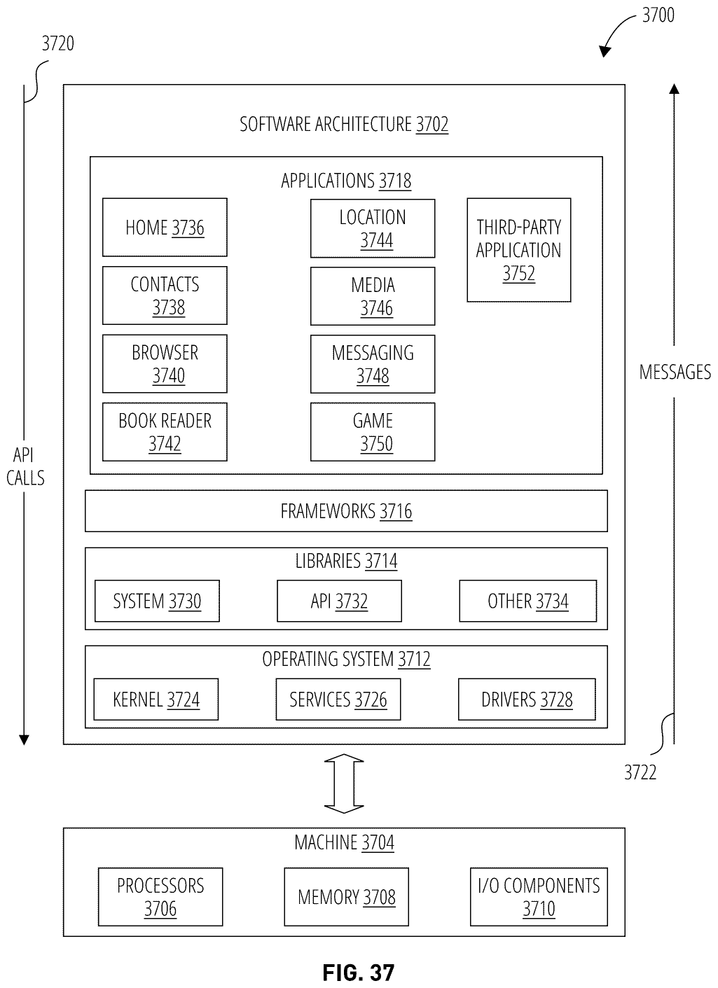

FIG. 37 is a block diagram 3700 illustrating a software architecture 3702, which can be installed on any one or more of the devices herein. FIG. 37 is merely a non-limiting example of a software architecture, and it will be appreciated that many other architectures can be implemented to facilitate the functionality described herein. In various embodiments, the software architecture 3702 is implemented by hardware such as a machine 3704 of FIG. 37 that includes processors 3706, memory 3708, and I/O component 3710. In this example architecture, the software can be conceptualized as a stack of layers where each layer may provide particular functionality. For example, the software includes layers such as an operating system 3712, libraries 3714, frameworks 3716, and applications 3718. Operationally, the applications 3718 invoke application programming interface (API) calls (API calls) 3720 through the software stack and receive messages 3722 in response to the API calls 3720, consistent with some embodiments.

In various implementations, the operating system 3712 manages hardware resources and provides common services. The operating system 3712 includes, for example, a kernel 3724, services 3726, and drivers 3728. The kernel 3724 acts as an abstraction layer between the hardware and the other software layers, consistent with some embodiments. For example, the kernel 3724 provides memory management, processor management (e.g., scheduling), component management, networking, and security settings, among other functionality. The services 3726 can provide other common services for the other software layers. The drivers 3728 are responsible for controlling or interfacing with the underlying hardware, according to some embodiments. For instance, the drivers 3728 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 3714 provide a common low-level infrastructure utilized by the applications 3718. The libraries 3714 can include system libraries 3730 (e.g., C standard library) that can provide functions such as memory allocation functions, string manipulation functions, mathematic functions, and the like. In addition, the libraries 3714 can include API libraries 3732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 3714 can also include a wide variety of other libraries 3734 to provide many other APIs to the applications 3718.

The frameworks 3716 provide a common high-level infrastructure that can be utilized by the applications 3718, according to some embodiments. For example, the frameworks 3716 provide various graphical user interface (GUI) functions, high-level resource management, high-level location services, and so forth. The frameworks 3716 can provide a broad spectrum of other APIs that can be utilized by the applications 3718, some of which may be specific to a particular operating system or platform.

In an example embodiment, the applications 3718 include a home application 3736, a contacts application 3738, a browser application 3740, a book reader application 3742, a location application 3744, a media application 3746, a messaging application 3748, a game application 3750, and a broad assortment of other applications such as a third-party application 3752. According to some embodiments, the applications 3718 are programs that execute functions defined in the programs. Various programming languages can be employed to create one or more of the applications 3718, structured in a variety of manners, such as object-oriented programming languages (e.g., Objective-C, Java, or C++) or procedural programming languages (e.g., C or assembly language). In a specific example, the third-party application 3752 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 3752 can invoke the API calls 3720 provided by the operating system 3712 to facilitate functionality described herein.

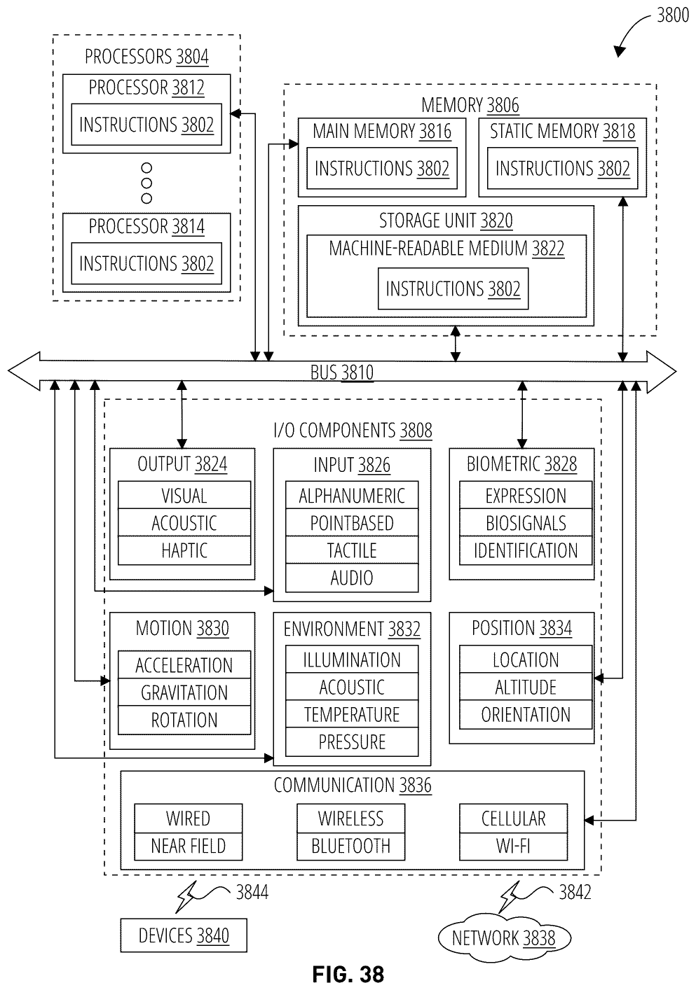

FIG. 38 illustrates a diagrammatic representation of a machine 3800 in the form of a computer system within which a set of instructions may be executed for causing the machine to perform any one or more of the methodologies discussed herein, according to example embodiments. Specifically, FIG. 38 shows a diagrammatic representation of the machine 3800 in the example form of a computer system, within which instructions 3802 (e.g., software, a program, an application, an applet, an app, or other executable code) for causing the machine 3800 to perform any one or more of the methodologies discussed herein may be executed. The instructions 3802 transform the general, non-programmed machine 3800 into a particular machine 3800 programmed to carry out the described and illustrated functions in the manner described. In alternative embodiments, the machine 3800 operates as a standalone device or may be coupled (e.g., networked) to other machines. In a networked deployment, the machine 3800 may operate in the capacity of a server machine or a client machine in a server-client network environment, or as a peer machine in a peer-to-peer (or distributed) network environment. The machine 3800 may comprise, but not be limited to, a server computer, a client computer, a personal computer (PC), a tablet computer, a laptop computer, a netbook, a set-top box (STB), a PDA, an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 3802, sequentially or otherwise, that specify actions to be taken by the machine 3800. Further, while only a single machine 3800 is illustrated, the term “machine” shall also be taken to include a collection of machines 3800 that individually or jointly execute the instructions 3802 to perform any one or more of the methodologies discussed herein.

The 3800 may include processors 3804, memory 3806, and I/O components 3808, which may be configured to communicate with each other such as via a bus 3810. In an example embodiment, the processors 3804 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 3812 and a processor 3814 that may execute the instructions 3802. The term “processor” is intended to include multi-core processors that may comprise two or more independent processors (sometimes referred to as “cores”) that may execute instructions contemporaneously. Although FIG. 38 shows multiple processors 3804, the machine 3800 may include a single processor with a single core, a single processor with multiple cores (e.g., a multi-core processor), multiple processors with a single core, multiple processors with multiples cores, or any combination thereof.

The memory 3806 may include a main memory 3816, a static memory 3818, and a storage unit 3820, both accessible to the processors 3804 such as via the bus 3810. The main memory 3816, the static memory 3818, and storage unit 3820 store the instructions 3802 embodying any one or more of the methodologies or functions described herein. The instructions 3802 may also reside, completely or partially, within the main memory 3816, within the static memory 3818, within machine-readable medium 3822 within the storage unit 3820, within at least one of the processors 3804 (e.g., within the processor's cache memory), or any suitable combination thereof, during execution thereof by the machine 3800.

The I/O components 3808 may include a wide variety of components to receive input, provide output, produce output, transmit information, exchange information, capture measurements, and so on. The specific I/O components 3808 that are included in a particular machine will depend on the type of machine. For example, portable machines such as mobile phones will likely include a touch input device or other such input mechanisms, while a headless server machine will likely not include such a touch input device. It will be appreciated that the I/O components 3808 may include many other components that are not shown in FIG. 38. The I/O components 3808 are grouped according to functionality merely for simplifying the following discussion, and the grouping is in no way limiting. In various example embodiments, the I/O components 3808 may include output components 3824 and input components 3826. The output components 3824 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 3826 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 3808 may include biometric components 3828, motion components 3830 environmental components 3832, or position components 3834, among a wide array of other components. For example, the biometric components 3828 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 3830 may include acceleration sensor components (e.g., accelerometer), gravitation sensor components, rotation sensor components (e.g., gyroscope), and so forth. The environmental components 3832 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 3834 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 3808 may include communication components 3836 operable to couple the machine 3800 to a network 3838 or devices 3840 via a coupling 3842 and a coupling 3844, respectively. For example, the communication components 3836 may include a network interface component or another suitable device to interface with the network 3838. In further examples, the communication components 3836 may include wired communication components, wireless communication components, cellular communication components, Near Field Communication (NFC) components, Bluetooth® components (e.g., Bluetooth® Low Energy), Wi-Fi components, and other communication components to provide communication via other modalities. The devices 3840 may be another machine or any of a wide variety of peripheral devices (e.g., a peripheral device coupled via a USB).

Moreover, the communication components 3836 may detect identifiers or include components operable to detect identifiers. For example, the communication components 3836 may include Radio Frequency Identification (RFID) tag reader components, NFC smart tag detection components, optical reader components (e.g., an optical sensor to detect one-dimensional barcodes such as Universal Product Code (UPC) barcode, multi-dimensional bar codes such as Quick Response (QR) code, Aztec code, Data Matrix, Dataglyph, MaxiCode, PDF417, Ultra Code, UCC RSS-2D barcode, and other optical codes), or acoustic detection components (e.g., microphones to identify tagged audio signals). In addition, a variety of information may be derived via the communication components 3836, such as location via Internet Protocol (IP) geolocation, location via Wi-Fi® signal triangulation, location via detecting an NFC beacon signal that may indicate a particular location, and so forth.

The various memories (i.e., memory 3806, main memory 3816, static memory 3818, and/or memory of the processors 3804) and/or storage unit 3820 may store one or more sets of instructions and data structures (e.g., software) embodying or utilized by any one or more of the methodologies or functions described herein. These instructions (e.g., the instructions 3802), when executed by processor 3804, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 4320 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 3838 or a portion of the network 3838 may include a wireless or cellular network, and the coupling 3842 may be a Code Division Multiple Access (CDMA) connection, a Global System for Mobile communications (GSM) connection, or another type of cellular or wireless coupling. In this example, the coupling 3842 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 3802 may be transmitted or received over the network 3838 using a transmission medium via a network interface device (e.g., a network interface component included in the communication components 3836) and utilizing any one of a number of well-known transfer protocols (e.g., hypertext transfer protocol (HTTP)). Similarly, the instructions 3802 may be transmitted or received using a transmission medium via the coupling 3844 (e.g., a peer-to-peer coupling) to the devices 3840. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 3802 for execution by the machine 3800, and includes digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A computer-implemented method executed on a computing device comprising a processor and memory for managing loans and subscriptions in a multi-tenant environment, the computer-implemented method comprising:
in a first user session:
receiving, via a first user interface element of a user interface, first order data relating to a first subscription offering, the first order data including a first set of attributes relating to the first subscription offering;
incorporating the first order data into an encrypted subscription data structure stored in the memory, the encrypted subscription data structure including quantity data and period data for the first subscription offering;
calculating, by the processor, a one-time payment amount for the first subscription offering based on the quantity data;
calculating, by the processor, a periodic monthly subscription payment amount for the first subscription offering based on the quantity data and the period data;
automatically communicating, by the processor, the one-time payment amount and periodic monthly subscription payment amount to a financial exchange system via an API;
receiving a first financing offer under a first loan related to the first subscription offering;
causing presentation of both the one-time payment amount and the periodic monthly subscription payment amount;
causing presentation of the first financing offer in the first user interface element;
based on a user acceptance of and access to the first loan, receiving a first payment via the user interface, for the one-time payment amount or the periodic monthly subscription payment amount; and
processing the first payment in a check out flow in the first user session.

2. The computer-implemented method of claim 1, further comprising:
in a second user session:
receiving a second payment via the user interface;
determining whether a payment under the first loan is due, or whether the first loan is paid off;
based on a determination that a payment under the first loan is due, applying the second payment to the first loan by the processor; or
based on a determination that the first loan is paid off, applying the second payment as a credit to a user account by the processor, or as payment for an item or service in a check out flow in the second user session; and
processing the second payment by the processor and updating the encrypted subscription data structure.

3. The computer-implemented method of claim 1, wherein the credit is applied to a digital wallet associated with the user account.

4. The computer-implemented method of claim 3, further comprising receiving a user request to access the digital wallet in a check out flow during the first or second user session.

5. The computer-implemented method of claim 1, further comprising, in the first user session:
receiving, via a second user interface element of the user interface, second order data related to a second subscription offering, the second order data including a second set of attributes related to the second subscription offering;
incorporating the second order data into the encrypted subscription data structure, the encrypted subscription data structure including quantity data and period data for the second subscription offering;
calculating a one-time payment amount and a periodic monthly subscription payment amount for the second subscription offering;
automatically communicating the one-time payment amount and periodic monthly subscription payment amount for the second subscription offering to the financial exchange system via the API;
receiving a second financing offer under a second loan related to the second subscription offering;
causing presentation, in the second user interface element, of the one-time payment amount and the periodic monthly subscription payment amount for the second subscription offering; and
causing presentation of the second financing offer in the second user interface element.

6. The computer-implemented method of claim 5, further comprising:
presenting a toggle feature in the user interface to toggle between presentations of the first and second user interface elements.

7. The computer-implemented method of claim 5, further comprising:
receiving third order data relating to a third offering, the third offering having a one-time payment option only, the method further comprising a presentation of a one-time payment amount related to the third offering.

8. The computer-implemented method of claim 5, wherein each of the first and second sets of attributes comprises an item identifier associated with at least one of an item or a service.

9. The computer-implemented method of claim 5, wherein each of the first and second set of attributes comprises a recurring attribute identifying the respective offering as being a recurring offering, and wherein the first and second order data is incorporated based on the recurring attribute.

10. The computer-implemented method of claim 5, wherein the financial exchange system provides financing options relating to the periodic monthly subscription payment amounts to financiers.

11. The computer-implemented method of claim 5, wherein the communication of the periodic monthly subscription payment amounts includes communicating further information pertaining to each of the first and second subscription offerings, the further information including identification information for a provider and consumer of the offerings.

12. The computer-implemented method of claim 5 wherein the first financing offer and second financing offer comprise financing terms, the method further including communicating the financing offers from the financial exchange system to be presented via the user interface.

13. The computer-implemented method of claim 5, wherein the financing offers include a first financing offer pertaining to the first subscription offering and a second financing offer pertaining to the second subscription offering.

14. The computer-implemented method of claim 5, wherein predefined business rules are applied to selectively present at least one of the first or second financing offers via the user interface.

15. A computing system for managing loans and subscriptions, comprising:
a multi-tenant server executing a loan and subscription management platform and having a processor and memory storing instructions;
a client device including a user interface, the client device communicatively coupled to the multi-tenant server;
wherein the instructions, when executed by the processor, cause the multi-tenant server to perform operations comprising at least:
in a first user session:
receiving, via a first user interface element of a user interface, first order data relating to a first subscription offering, the first order data including a first set of attributes relating to the first subscription offering;
incorporating the first order data into an encrypted subscription data structure stored in the memory, the encrypted subscription data structure including quantity data and period data for the first subscription offering;
calculating, by the processor, a one-time payment amount for the first subscription offering based on the quantity data;
calculating, by the processor, a periodic monthly subscription payment amount for the first subscription offering based on the quantity data and the period data;
automatically communicating, by the processor, the one-time payment amount and periodic monthly subscription payment amount to a financial exchange system via an API;
receiving a first financing offer under a first loan related to the first subscription offering;
causing presentation of both the one-time payment amount and the periodic monthly subscription payment amount;
causing presentation of the first financing offer in the first user interface element;
based on a user acceptance of and access to the first loan, receiving a first payment via the user interface, for the one-time payment amount or the periodic monthly subscription payment amount; and
processing the first payment in a check out flow in the first user session.

16. The computing system of claim 15, wherein the operations further comprise:
in a second user session:
receiving a second payment via the user interface;
determining whether a payment under the first loan is due, or whether the first loan is paid off;
based on a determination that a payment under the first loan is due, applying the second payment to the first loan by the processor; or
based on a determination that the first loan is paid off, applying the second payment as a credit to a user account by the processor, or as payment for an item or service in a check out flow in the second user session; and
processing the second payment by the processor and updating the encrypted subscription data structure.

17. The computing system of claim 15, wherein the credit is applied to a digital wallet associated with the user account.

18. The computing system of claim 17, wherein the operations further comprise processing a user request to access the digital wallet in a check out flow during the first or second user session.

19. The computing system of claim 15, wherein the instructions further cause the multi-tenant server to:
receive, via a second user interface element of the user interface, second order data related to a second subscription offering, the second order data including a second set of attributes related to the second subscription offering;
incorporate the second order data into the encrypted subscription data structure, the encrypted subscription data structure including quantity data and period data for the second subscription offering;
calculate a one-time payment amount and a periodic monthly subscription payment amount for the second subscription offering;
automatically communicate the one-time payment amount and periodic monthly subscription payment amount for the second subscription offering to the financial exchange system via the API;
receive a second financing offer under a second loan related to the second subscription offering;
cause presentation, in the second user interface element, of the one-time payment amount and the periodic monthly subscription payment amount for the second subscription offering; and
cause presentation of the second financing offer in the second user interface element.

20. The computing system of claim 19, wherein the instructions further cause the multi-tenant server to:
present a toggle feature in the user interface to toggle between presentations of the first and second user interface elements.

21. The computing system of claim 19, wherein the instructions further cause the multi-tenant server to:
receive third order data relating to a third offering, the third offering having a one-time payment option only, and
present the one-time payment amount related to the third offering.

22. The computing system of claim 19, wherein each of the first and second sets of attributes comprises an item identifier associated with at least one of an item or a service.

23. The computing system of claim 19, wherein each of the first and second set of attributes comprises a recurring attribute identifying the respective offering as being a recurring offering, and wherein the first and second order data is incorporated based on the recurring attribute.

24. The computing system of claim 19, wherein the financial exchange system provides financing options relating to the periodic monthly subscription payment amounts to financiers.

25. The computing system of claim 19, wherein the communication of the periodic monthly subscription payment amounts includes communicating further information pertaining to each of the first and second subscription offerings, the further information including identification information for a provider and consumer of the offerings.

26. The computing system of claim 19 wherein the first financing offer and second financing offer comprise financing terms, and wherein the financing offers are communicated from the financial exchange system to be presented via the user interface.

27. The computing system of claim 26, wherein the financing offers include a first financing offer pertaining to the first subscription offering and a second financing offer pertaining to the second subscription offering.

28. The computing system of claim 27, wherein predefined business rules are applied to selectively present at least one of the first or second financing offers via the user interface.

29. A non-transitory computer-readable storage medium, the computer-readable storage medium including instructions that when executed by a computer, cause the computer to perform operations comprising at least:
in a first user session:
receiving, via a first user interface element of a user interface, first order data relating to a first subscription offering, the first order data including a first set of attributes relating to the first subscription offering;
incorporating the first order data into an encrypted subscription data structure stored in the memory, the encrypted subscription data structure including quantity data and period data for the first subscription offering;
calculating, by the processor, a one-time payment amount for the first subscription offering based on the quantity data;
calculating, by the processor, a periodic monthly subscription payment amount for the first subscription offering based on the quantity data and the period data;
automatically communicating, by the processor, the one-time payment amount and periodic monthly subscription payment amount to a financial exchange system via an API;
receiving a first financing offer under a first loan related to the first subscription offering;
causing presentation of both the one-time payment amount and the periodic monthly subscription payment amount;
causing presentation of the first financing offer in the first user interface element;
based on a user acceptance of and access to the first loan, receiving a first payment via the user interface, for the one-time payment amount or the periodic monthly subscription payment amount; and
processing the first payment in a check out flow in the first user session.

30. The non-transitory computer-readable storage medium of claim 29, wherein the operations further comprise:
in a second user session:
receiving a second payment via the user interface;
determining whether a payment under the first loan is due, or whether the first loan is paid off;
based on a determination that a payment under the first loan is due, applying the second payment to the first loan by the processor; or
based on a determination that the first loan is paid off, applying the second payment as a credit to a user account by the processor, or as payment for an item or service in a check out flow in the second user session; and
processing the second payment by the processor and updating the encrypted subscription data structure.
